(19) United States
(12) Patent Application Publication
(10) Pub. No.: US 2009/0319331 A1
(43) Pub. Date: Dec. 24, 2009

(54) METHODS AND APPARATUS TO RESPOND TO RECALLS

(76) Inventors: Michael Day Duffy, Glenview, IL (US); Bart Bronnenberg, Geulle (NL)

Correspondence Address: Hanley, Flight & Zimmerman, LLC, 150 S. Wacker Dr. Suite 2100, Chicago, IL, 60606, US

(21) Appl. No.: 12/142,037

(22) Filed: Jun. 19, 2008

(51) Int. Cl. G06F 17/30; G06Q 10/00; G06Q 90/00

(52) U.S. Cl. 705/10; 705/1

(57) ABSTRACT

Methods and apparatus to respond to recalls are disclosed. An example method includes receiving product recall information and generating at least one store cohort based on the received product recall information to represent a plurality of stores spatially arranged based on relative similarities to at least one channel. The example method also includes generating at least one ranked list of contact information based on the at least one store cohort, and disseminating the received product recall information to an entity associated with the contact information.

### FIELD OF THE DISCLOSURE

This disclosure relates generally to market research, and, more particularly, to methods and apparatus to respond to recalls.

### BACKGROUND

Product recalls are issued on a daily basis by the United States Food and Drug Administration (FDA). The FDA typically categorizes recall actions in one of three classes, in which each class represents a varying different degree of severity. A Class I recall, for example, includes a situation in which a reasonable probability exists that serious adverse health consequences or death will occur in response to use of, or exposure to a suspect product. Such Class I recalls may include products having toxin(s), undeclared allergens, labeling errors for lifesaving drugs, and/or defective components of a lifesaving device.

A Class II recall, on the other hand, is a situation of lesser severity than a Class I recall. In a Class II recall the use of, or exposure to the suspect product may cause a temporary or medically reversible adverse health consequence. Such Class II recalls may include products that are under-strength, but not used to treat life-threatening situations.

Finally, a Class III recall is a situation in which use of, or exposure to the suspect product is not likely to cause adverse health consequences, but that violate one or more FDA labeling or manufacturing laws, such as a lack of English labeling for a retail food product.

In some situations, the FDA contacts known retailers directly to inform them of the suspect product with instructions to remove such product(s) from the stream of commerce. While the FDA may be able to handle contacting a relatively small number of retailers with respect to a low volume product that requires a recall, some products penetrate the stream of commerce with a relatively high volume, thereby making a manual process of contact difficult or impossible in a reasonable amount of time. Affected products may include automotive products, consumer electronics, food, toys, health products, and/or medical devices. In the event of a recall for a relatively high volume product, tens of thousands of retailers may require prompt notification to protect consumers.

### BRIEF DESCRIPTION OF THE DRAWINGS

FIG. 1 is a block diagram of an example system configured to respond to recalls.

FIG. 2 is an example rapid response cohort system that may be used with the system of FIG. 1 to predict sales.

FIG. 3 illustrates a table of an example portion of a product reference library.

FIG. 4 illustrates a table of example stores arranged by channel and sub-channel.

FIG. 5A illustrates example data structures generated by the example rapid response cohort system of FIG. 2.

FIG. 5B illustrates example hierarchies used by the example rapid response cohort system of FIG. 2.

FIG. 6 depicts a table of example prediction and reference data used by the example rapid response cohort system of FIG. 2.

FIGS. 7 and 8 illustrate example outputs of the rapid response cohort system of FIG. 2.

FIGS. 9-12, 14, and 16 are flowcharts representative of example machine readable instructions that may be executed to implement one or more of the entities of the example system of FIG. 2.

FIG. 13 illustrates an example table of store detail.

FIG. 15 illustrates an example table of pre-recall and post-recall sales per store.

FIG. 17 is a block diagram of an example processor system that may be used to execute the example machine readable instructions of FIGS. 9-12, 14, and 16 to implement the example systems, apparatus, and/or methods described herein.

### DETAILED DESCRIPTION

United States based food companies report that their primary concern with respect to recall situations is speed. In fact, a majority of food companies report that, in the event of a recall, the response time to remove suspect product(s) is measured in days, during which time the product(s) continue to be available to unwary consumers. Additionally, those food companies report that their secondary concern relates to challenges presented in view of non-standardized processes to deal with recall situations when they occur.

Although the task of notifying mass numbers of retailers and/or consumers is daunting for the United States Food and Drug Administration (FDA), the FDA typically lacks the information resources necessary to pinpoint affected areas. As a result, the FDA typically relies on one or more media outlets (e.g., television news programs, radio broadcasts, newspaper, etc.), but the precise geographic areas affected may not be known at the time a suspect product is identified as a candidate for recall. Such lack of knowledge regarding the affected geographic area(s) introduces delay in the dissemination of potentially injury preventing or even life-saving information to consumers and/or retailers.

Additionally, the FDA typically does not have access to detailed information regarding product supply chain shipping routes, which prevents opportunities to keep the suspect products out of consumers' hands in the first place. Allowing such suspect products to eventually get into the consumers' hands creates a negative association of the suspect product by the consumers after the recall instructions have been lifted. Even months or years after a recall has been lifted from a product, consumers may continue to associate the trademarks associated with the previously recalled product in a negative manner, thereby negatively affecting sales even though the product is now safe.

Market research companies have been collecting data related to consumer behavior and product sales for many years. As a result, some market research companies have amassed considerable detailed data with respect to retail stores, point-of-sale (POS) data feeds, purchasing behavior of statistically selected panelists in one or more represented demographic areas, product supply chain data feeds (e.g., shipping channels, shipping warehouses, trucking routes, etc.), and/or product references that contain detailed data about each Universal Product Code (UPC) and the details associated with the product matched to the UPC.

In one example, the market research companies have developed numerous techniques to measure consumer behavior, retailer/wholesaler characteristics, and/or marketplace demands. For example, the Nielsen Company has long marketed consumer behavior data collected under its Homescan® system. The Homescan® system employs a panelist based methodology to measure consumer behavior and identify sales trends. In the Homescan® system, households, which together are statistically representative of the demographic composition of a population to be measured, are retained as panelists. These panelists are provided with home scanning equipment and agree to use that equipment to identify, and/or otherwise scan the Universal Product Code (UPC) of every product they purchase and to note the identity of the retailer or wholesaler (collectively or individually “merchant”) from which the corresponding purchase was made. The data collected via this scanning process is periodically exported to the Nielsen Company, where it is compiled into one or more databases. The data in the databases is analyzed using one or more statistical techniques and methodologies to create reports of interest to manufacturers, retailers/wholesalers, and/or other business entities. These reports provide business entities with insight into one or more trends in consumer purchasing behavior with respect to products available in the marketplace.

However, these reports also allow identification of circumstances in which a suspect product was purchased. In particular, because Homescan® panelists are willing participants, geographic information of such panelists is known, thereby allowing for identification of areas affected by the FDA recall instructions. Additionally, because the Homescan® panelists also disclose when and where products were purchased, information related to the exact retailer that is selling the suspect product is readily ascertained.

Market research companies also monitor and/or analyze marketplace demands and demographic information related to one or more products in different geographic boundaries. For example, the Nielsen Company compiles reliable marketing research demographic data and market segmentation data via its Claritas® and Spectra® services. These services provide this demographic data and market segmentation data on, for example, geographic regions of interest basis and, thus, allow a merchant to, for instance, determine optimum site locations and/or customer advertisement targeting based on, in part, demographics of a particular region. For example, southern demographic indicators may suggest that barbecue sauce sells well during the winter months while similar products do not appreciably sell in northern markets until the summer months.

Knowledge related to a product and its particular strengths and/or weaknesses within a particular geographic region allow for the determination of which geographic regions may be most greatly affected by a recall of the suspect product. For example, in the event of a recall for barbecue sauce during the winter months, knowledge that the relative demand for barbecue sauce is relatively low for Northern markets while relatively high for particular Southern markets allows FDA notification efforts to be pinpointed with greater accuracy. As a result, such suspect products have the opportunity to be removed from shelves in a more timely manner.

The Claritas® services also include BusinessPoint™, which contains exhaustive data related to business data, including geographic information, business name, and/or practitioner details. For example, BusinessPoint™ data identifies the names and addresses for medical personnel for any given geographic area. Further, the BusinessPoint™ data specifies whether such medical personnel are physicians, and the particular medical specialties that such physicians practice. Thus, for example, in the event of an FDA recall for a food product that may cause severe stomach sickness, the BusinessPoint™ data may be accessed to identify the names, addresses, and/or telephone numbers for any of gastrointestinal specialists, disease specialists, and/or allergy specialists in the affected area. Without limitation, the BusinessPoint™ data may specify the nearest hospitals in the affected area so that they may be placed on notice if and when consumers arrive with specific symptoms.

The Nielsen Company also categorizes merchants (e.g., retailers and/or wholesalers) and/or compiles data related to characteristics of stores via its TDLinx® system. In the TDLinx® system, data is tracked and stored that is related to, in part, a merchant store parent company, the parent company marketing group(s), the number of store(s) in operation, the number of employee(s) per store, the geographic address and/or phone number of the store(s), and the channel(s) serviced by the store(s). As described in further detail below, channels may include supermarkets, convenience stores, drug stores, mass merchandisers, and/or liquor stores. For each retailer in the TDLinx® system, a contact phone number, e-mail address(es), web-page address(es), street address, latitude, and/or longitude is available to permit efficient contact and location. Additionally, the TDLinx® system contains information related to the parent company (if any) so that FDA notification information may be sent to both the immediately affected retail location(s) as well as the parent company. As a result, the parent company is put on immediate notice and may also implement further pressure on one or more individual retail location(s) to immediately pull the suspect product from the shelves.

Market research companies also monitor and/or analyze point of sale data with respect to one or more merchants in different market segments. For example, the Nielsen Company has long compiled data via its Scantrack® system. In the Scantrack® system, merchants install equipment at the point of sale (POS) that records the UPC code of every sold product, the quantity sold, the sales price, and the date on which the sale occurred. The POS data collected at the one or more stores is periodically exported to the Nielsen Company where it is compiled into one or more databases. The POS data in the databases is analyzed using one or more statistical techniques and/or methodologies to create reports of interest to manufacturers, wholesalers, retailers, and/or other business entities. These reports provide manufacturers and/or merchants with insight into one or more sales trends with respect to products available in the marketplace. For example, the reports reflect the sales volumes of one or more products at one or more merchants.

As a result of determining the sales trends related to products in the marketplace, the methods and apparatus described herein can better identify where the suspect products may experience the greatest consumer demand and/or sales. For example, in the event that a product sales trend is identified via the Scantrack® data, and if that product is also identified by the FDA as a suspect product for recall, then recall notification efforts may be pinpointed to the retailers and/or geographic locations that illustrate the greatest sales trend activity.

Product reference information is also maintained in one or more data systems. For example, the Nielsen Company maintains a Product Reference Library (PRL) that codes more than 700,000 items, in which each item includes an average of forty (40) descriptive characteristics. The characteristics for each item may include, but are not limited to, manufacturer name, product size, brand, flavor, lot number, serial number, package type, and/or nutritional information. Additionally, the PRL also includes the associated UPC for the product. Many products sold by manufacturers have several permutations of size, quantity, color schemes, and/or packaging shapes that may make pinpoint identification difficult. In the event that the FDA issues a recall for a described product, the PRL may allow the suspect product to be identified with greater accuracy, and the corresponding UPC to be determined so that retailers can pull that product from shelves in a more accurate manner.

Obtaining meaningful projections from these one or more data sources typically includes defining a specific universe of interest, taking measurements related to points of interest, and mathematically extrapolating to project account sales, brand penetration, item distribution, and/or item assortments. Such projections, thus, allow for the identification of which retailers and/or which geographic locations have the suspect product for sale. However, with the increase of specialty channels, such as discount stores, specialty food stores, large hardware stores, and/or office supply stores, a specifically identified universe of interest may not adequately reflect product coverage. For example, while traditionally grocery stores were the primary retail channel to sell glass cleaners (e.g., Windex®), specialty channels now represent a significant portion of glass cleaner sales, thereby diluting indicators for such product coverage.

Market research in the United States is typically analyzed in view of geographic regions. For example, a market research entity may divide the United States into a West, Midwest, Northeast, and Southern region. Within each region, the geographic analysis is further sub-categorized into divisions. For example, the West region includes a Pacific division and a Mountain division, the Midwest region includes a West North Central division and an East North Central division, the Northeast region includes a Middle Atlantic division and a New England division, and the Southern region includes a West South Central division, an East South Central division, and a South Atlantic division. Market research and/or market research entities may categorize the United States and/or any other country and/or geographic region into any other groups and/or subgroup(s) of interest. Without limitation, other geographic regions may include manufacturer sales territories, retailer trading areas, major markets, and/or regions covered by specific media (e.g., radio, television, newspaper).

Market researchers and/or clients (e.g., clients that hire market research entities for market research services) interested in sales volume may focus their analysis based on, for example, total regional sales (e.g., total US sales, Midwest regional sales, etc.), sales over a time of interest (e.g., quarterly, weekly, annually, etc.), and/or sales in view of one or more channels (e.g., grocery retailers, hardware retailers, specialty retailers, etc.). Additionally, the market researchers and/or clients may employ one or more tools and/or data from one or more tools to determine sales volume and/or sales trends. For example, the Homescan® system, the Claritas® system, the Spectra® system, the Scantrack® system, and/or the TDLinx® system may be employed for such purposes. However, some of the merchants within any particular geographic region may not willingly participate/cooperate with market research companies, thereby keeping their sales and/or customer data confidential.

While many merchants have traditionally been willing to cooperate with market research companies to develop various forms of market analysis information, such as POS data, a significant percentage of retail sales come from retailers that refuse to cooperate with market research companies. For example, some retailers and/or merchants offer only limited access to POS statistics to key suppliers within selected categories of product. Furthermore, some of the limited data and/or statistics that are provided by some retailers and/or merchants have limited value in view of the cleanliness of the data. For example, a retailer and/or a merchant may provide data to a key supplier that includes a volume of dog food cans sold. However, the particular type of dog food sold (e.g., the dog-food flavor, the size of the dog food container, etc.) may not be identified, or the cashier may simply scan a single can of dog food purchased by a consumer and multiply that UPC by the total quantity purchased without regard to the types of dog food actually sold (e.g., how many beef flavored cans sold, how many chicken flavored cans sold, etc.). As a result, in the event of an FDA recall notice for a product, information is not available with respect to whether or not retailers and/or merchants sell the suspect product. Additionally, information is not available with respect to whether or not such retailers and/or merchants complied with the FDA recall instructions.

Additionally, because merchants within one or more specialty channels (e.g., discount stores, office supply stores, etc.) sell products which are often also sold in traditional channels (e.g., grocery stores), the presence of specialty channel sales causes product coverage to be reduced when performing market analysis for a traditional universe of merchant types/channels. For example, while a traditional channel, such as a grocery store, was historically the primary merchant to sell glass cleaner (e.g., Windex®), merchants and/or retailers in specialty channels, such as office supply stores now also sell the same product types and/or product brands. Traditionally, the market research company could identify a grocery store channel, determine how many similar grocery store data points existed (e.g., how many retail and/or merchant stores had POS data available), take measurements, and then create accurate projections across the market space of interest via extrapolation of sales figures, trending, etc. Prior to the rise of specialty merchants, product coverage data may have been, for example, over 75% for a given product when the market research company identified a specific universe of merchants and performed such extrapolation techniques. Today, however, the existence of the specialty channels now reduces product coverage to around, for example, 40% for that same product when such traditional analysis techniques are employed.

Generally speaking, prior sales estimate development efforts for a group of clearly defined types of stores (e.g., grocery, drug, convenience, etc.) typically relied on: (1) a census of the universe (i.e., the one or more geographic region(s) of interest); (2) one or more measurements from a representative sample; and (3) projecting sample measures to the defined universe. However, if a particular retailer does not cooperate, the sample is not typically considered representative. Moreover, without a representative understanding of where products may reside in the stream of commerce, attempts at prompt notification to affected retailers and/or geographic regions may be hindered, thereby allowing the suspect product to remain on store shelves for longer periods of time.

As discussed in further detail below, predictions, as opposed to projections, allow for improved coverage. In this patent, a prediction includes, but is not limited to, a prediction of an outcome or behavior of a target group based on a study group in which members of the study group share one or more characteristics which are similar to the target group of interest. As discussed in further detail below, data related to a first study group of stores having similar characteristics is used to make a prediction relative to a larger target group of stores. Predictions to a larger target group made in view of one or more smaller study group(s) of stores formed based on similar(ities) in characteristic(s) of those stores exhibit greater accuracy than prior art based on merely projecting based on a mean-value of sampled stores. In the illustrated examples described below, data collected from multiple market data sources (e.g., Homescan®, Claritas®, Scantrack®, PRL, and/or TDLinx®) is processed with one or more spatial modeling techniques to define one or more store cohorts to be used for store predictions. In this patent, a cohort is defined as a set of stores selected based on a degree of similarity to one or more retail and/or wholesale channels (e.g., food, specialty foods, clothing, specialty clothing, maternity clothing, etc.), one or more geographic location(s), one or more trading area shopper profile(s), one or more retailer/wholesaler characteristic(s), and/or one or more thresholds of a quantity of product sold in each of the set of stores. Additionally, one or more cohorts may be defined based on one or more medical personnel, one or more specialties associated with the medical personnel, and/or the relative geographical proximity of relevant medical personnel to the areas affected by a recall. Further, once a cohort is defined, sales predictions are derived in view of characteristic similarities of those stores within the selected channel. Example methods and systems described herein use these multiple market data sources to determine similarities when generating cohorts. Possible points of similarity that may be used for analysis once the cohort is generated include one or more store characteristics, shopper profiles, POS sales data, reported panelist purchase data, and/or account purchase profiles. The example systems and methods illustrated herein facilitate sales related predictions such as baseline sales, new product forecasts, consumer demand, and/or sources of volume. These sales predictions, in turn, facilitate determining strategic directions for national share reporting, net regional development, and/or channel growth opportunities. Additionally, such sales predictions facilitate determining where a suspect product identified by the FDA for recall may be located within the stream of commerce. Data acquired from the multiple market sources is aggregated, which facilitates (1) better coverage, (2) relative product and store analysis, (3) trending, (4) and/or identification of key geographies likely to be affected by the specific FDA recall.

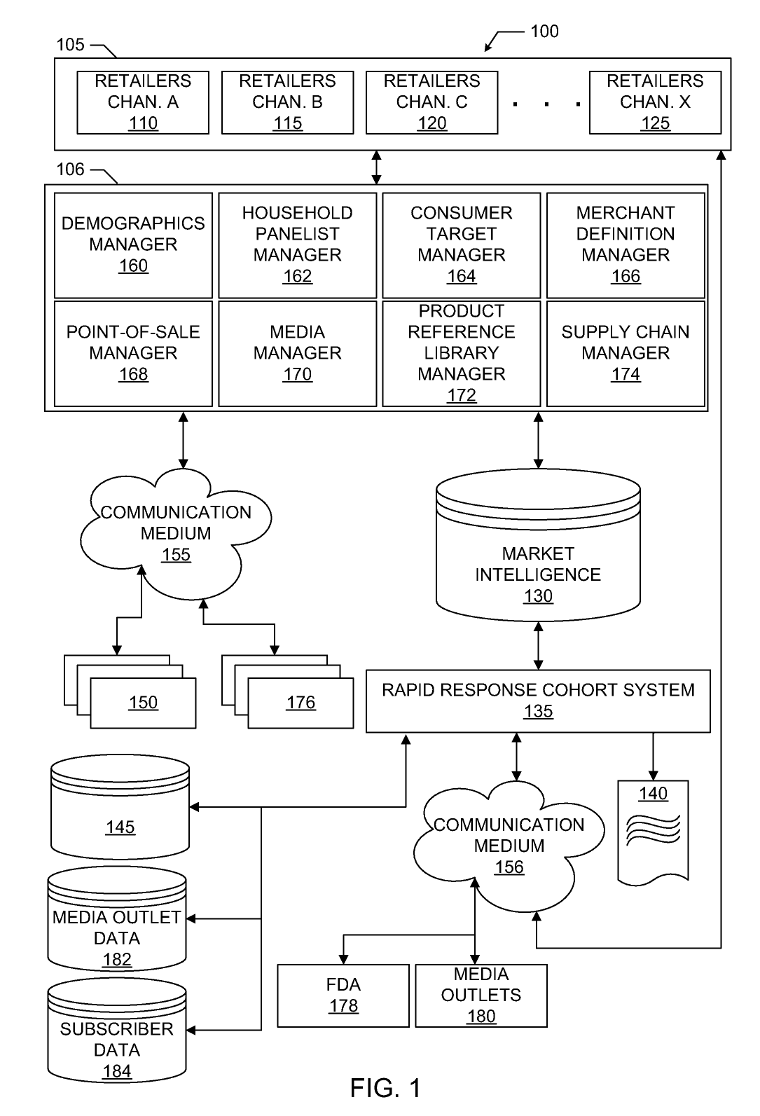

FIG. 1 is an illustration of an example system 100 to respond to recalls. In the illustrated example of FIG. 1, the system 100 is structured to analyze a merchant pool 105. In the illustrated example of FIG. 1, the pool 105 includes one or more retailers and/or wholesalers for which market data is made available, collected, and/or analyzed by one or more data collector(s) 106. As described above, the data collector(s) 106 may be implemented by any type(s) of market research tool(s) and/or data system(s) 150 such as, for example, the Homescan® system which provides panelist consumer behavior data, the Claritas® and/or Spectra® services, which provide regional demographics and consumer target data, the TDLinx® system which provides retail store characteristics, and/or the Scantrack® system which provides POS data. The example data collector 106 is communicatively coupled to the data systems 150 via, for example, a communication medium 155 such as a network, an intranet, and/or the Internet.

In the illustrated example of FIG. 1, the data collector 106 includes a demographics manager 160 to interface with the Claritas® services and/or databases (and/or other similar database(s)) to obtain information used with the methods and apparatus described herein. Similarly, the example data collector 106 includes a household panelist manager 162, a consumer target manager 164 to interface with Spectra® services and/or other similar database(s), a merchant definition manager 166 to interface with TDLinx® services and/or other similar database(s), a point-of-sale manager 168 to interface with Scantrack® services and/or other similar database(s), and a media manager 170, such as the Grabix® systems, to interface with appropriate data systems 150. Although the illustrated example of FIG. 1 includes specific examples of data systems 150 (i.e., Homescan®, Spectra®, TDLinx®, Scantrack®, and Grabix®), the methods and apparatus described herein are not limited thereto. Any additional and/or alternate data systems may be employed.

Additionally, the example data collector 106 of FIG. 1 includes a product reference library (PRL) manager 172 to interface with one or more data sources containing product characteristics information, such as the Nielsen PRL. As described above, the Nielsen PRL may contain specific details related to a product including, but not limited to, the manufacturer, size, brand, flavor, lot number, serial number, and/or nutritional information. The example data collector 106 of FIG. 1 also includes a supply chain manager 174 to interface with one or more distribution facilities/services 176 containing information related to distribution of products. At least one benefit of employing supply chain information during the FDA recall is to prevent and/or minimize further distribution of the suspect product. Distribution warehouses and/or trucking companies chartered with the responsibility of providing individual retailers with products may receive FDA recall notification from the methods and apparatus described herein, thereby reducing and/or preventing further distribution of suspect products. Such prevention of further distribution of the suspect product also allows the manufacturers to minimize damaging negative consumer impressions that may occur when recalled products ultimately make their way into consumer possession as such possession is reduced and/or avoided.

The data from the data collector 106 is stored in a market intelligence database 130. As described above, because some of the merchants in the example merchant pool 105 do not cooperate with the market research company operating the example system 100 of FIG. 1, the market data in the market intelligence database 130 may not include POS data collected from, for instance, the Scantrack® system for uncooperating merchants. However, the market intelligence database 130 may include purchase behavior data for the uncooperating merchants based on panelist data collected via, for example, the Homescan® system.

The example pool 105 as shown in FIG. 1 includes one or more merchants from one or more channels. In the illustrated example of FIG. 1, the pool 105 includes merchants from channel “A” 110, channel “B” 115, channel “C” 120, and/or any number of additional and/or alternate channels, represented by example channel “x” 125. The channels (e.g., A, B, C, x, etc.) may represent traditional channels, such as grocery stores, and/or specialty channels, such as office supply stores and/or discount stores. Data from the example pool 105 is harvested by the data collector(s) 106, which, as noted above, may include, but are not limited to, data from the Homescan® system, the Claritas® services, the Spectra® services, the TDLinx® system, PRL data source(s), and/or the Scantrack® system. This data is stored in the market intelligence database 130, which may incorporate any portion(s) or all of any of the information collected by the data collector(s) 106.

The example data collector(s) 106 of FIG. 1 are operatively coupled to an example rapid response cohort system 135 via the market intelligence database 130 and/or via one or more other channels of communication. In the illustrated example, the rapid response cohort system 135 is structured to develop one or more store cohorts that, among other things, facilitate sales related predictions, and/or facilitate an understanding of which retail store(s) are currently selling the suspect products recalled by the FDA, as discussed in further detail below. In the illustrated example of FIG. 1, the cohort system 135 produces output(s) 140 of one or more types such as, for example, sales volume data, tracking reports, drill-down analysis, account tracking and planning data, a list of retail stores currently selling the suspect products, and/or a list of the geographic locations in which the suspect product may have the greatest effect on consumers (e.g., a geographic area that currently sells, or is believed to have a demand for the suspect products). Additionally, the example cohort system 135 includes a data store 145 to save market data, calculated results, client output reports, and/or one or more example cohorts, as discussed in further detail below. Briefly, the resulting cohorts are made up of similar stores, some of which are cooperating retailers that provide POS data, and some of which are stores that do not provide POS data. Generally speaking, the more similar the stores are to each other, the more likely the measured POS data will predict the characteristics of the unmeasured stores.

Also in the illustrated example of FIG. 1, the rapid response cohort system 135 is communicatively coupled to a communication medium 156, which may be the same communication medium 155 described above. The example communication medium 156 facilitates communication from the FDA 178 so that recall information (e.g., product name, manufacturer, serial number, lot number, packaging type, photo of product) can be received by the rapid response cohort system 135. One or more media outlets may be communicatively coupled to the rapid response cohort system 135 so that dissemination of FDA recall information is targeted to geographic location(s) likely to be affected by the recall. For example, in the event that the rapid response cohort system 135 determines that, in response to receiving suspect product information from the FDA 178, the affected area is within the greater Chicago metropolitan area, the example rapid response cohort system 135 identifies contact information for one or more local (e.g., Chicago area) television stations, radio stations, and/or newspapers based on stored media outlet data 182. While the original FDA recall information received from the FDA 178 may not contain an abundance of detail, the example rapid response cohort system 135 retrieves further descriptive detail from the example product reference library manager 172. This further detailed information may be provided to the media outlets 180. As a result, the targeted media outlets 180 may be rapidly provided with sufficient detail for public dissemination, such as a photograph/image of the suspect product.

Similarly, the rapid response cohort system 135 of the illustrated example also forwards the detailed information related to the suspect product to the appropriate retailers 110, 115, 120, and/or 125 of the merchant pool 105 so that protective measures may be taken to protect the public. For example, the services rendered by the rapid response cohort system 135 may be based on a subscription service, in which subscriber information is stored in a subscriber database 184. Subscribers may include, but are not limited to, media outlets 180 (e.g., television stations that desire first-hand notification of recalls that may affect their viewing audience), retailers 110, 115, 120, and/or 125 of the merchant pool 105, retailers unassociated with the merchant pool 105, public interest groups, hospitals, and/or distribution facilities/services 176.

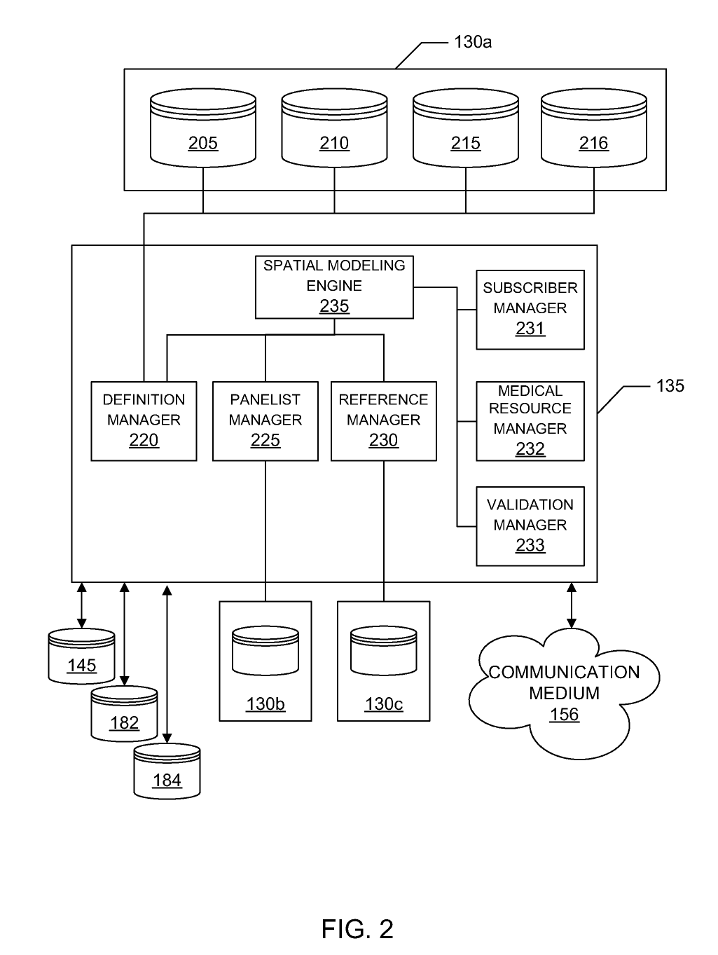

FIG. 2 is a schematic illustration of the example rapid response cohort system 135 of FIG. 1. In the illustrated example of FIG. 2, the rapid response cohort system 135 is communicatively coupled to a first portion of the market intelligence database 130a, a second portion of the market intelligence database 130b, and a third portion of the market intelligence database 130c. In the illustrated example, the first portion of the market intelligence database 130a includes store characteristics data 205, such as that provided by the TDLinx® system, shopper profile data 210, such as that provided by the Homescan® system, data indicative of marketplace demands and/or marketplace characteristics 215, such as that provided by the Claritas® and/or Spectra® services, and/or product reference data 216. In the illustrated example, the second portion of the market intelligence sources 130b includes panelist data, such as that provided by the Homescan® system. In the illustrated example, the third portion of the market intelligence database 130c includes POS data, such as that provided by the Scantrack® system.

The example cohort system 135 of FIG. 2 includes a cohort definition manager 220, a cohort panelist manager 225, a cohort reference manager 230, a subscriber manager 231, a medical resource manager 232, a validation manager 233, and a cohort spatial modeling engine 235. In the illustrated example of FIG. 2, the cohort spatial modeling engine 235 employs the services of the cohort definition manager 220, the cohort panelist manager 225, the cohort reference manager 230, and data from the FDA 178 to generate a relationship volume (e.g., a cube) and one or more store cohorts. In the illustrated example, each of approximately 400,000 stores is arranged in the relationship volume (e.g., cube) based on one or more characteristic similarities to one or more other stores, as discussed in further detail below. Without limitation, the number of arranged stores in the relationship cube may differ based on whether one or more stores have any relationship to one or more characteristics of interest. Further, stores having no relationship to one or more characteristics of interest may be eliminated from the relationship cube.

Generally speaking, during operation the example rapid response cohort system 135 of FIGS. 1 and 2 receives recall information from the FDA 178. During early stages of an FDA recall notice, explicit details may not be fully available, yet the recall notice may still be administered by the FDA in an abundance of caution. The recall information may include, but is not limited to the manufacturer name, the brand name, the quantity contained in each product package (e.g., 290 caplets). To supplement data unavailable to the FDA, the example rapid response cohort system 135 invokes the example product reference library manager 172, which is communicatively coupled to the Nielsen PRL, to obtain additional detail about the recalled product. While the Nielsen PRL is used herein for example purposes, any other data source/service may be employed to furnish detailed data related to the suspect product identified by the FDA.

The recall information received from the FDA and/or the additional detailed product information received via the PRL is used by the example rapid response cohort system 135 to generate one or more cohorts, as described in further detail below. The example cohort system 135 interacts with one or more data systems 150 (e.g., Claritas® data, Homescan® data, Spectra® data, TDLinx® data, and/or Scantrack® data, and/or data systems that provide demographics information, panelist information, consumer target profiling information, merchant definition information, point-of-sale information, media information, supply-chain information, and/or product reference information) to generate the cohort(s). Generally speaking, the cohort(s) are group(s) of stores that are exhibiting certain characteristics that are arranged in a manner that highlights one or more relationships between those characteristics. For example, if the example rapid response cohort system 135 is provided with recall information related to a suspect product such as Big Pharm caplets, then the example cohort system 135 generates a multi-dimensional cohort that identifies the retail stores that sell the suspect product. Each cell of the cohort represents one retailer. A retailer that most closely matches characteristic of interest (e.g., which retailer sells the most Big Pharm caplets) is located in the center of the cohort. Cells are placed around the center cell to represent other stores (general stores that sell fewer caplets than the retailer associated with the center cell). In general, cells that are located further away from the center cell sell fewer caplets than those closer to the center cell. Factors other than sales volumes can be used to place cells in the cohort (e.g., for example, when two stores show the same level of sales).

Using the generated cohorts, the rapid response cohort system 135 generates one or more ranked lists of most highly affected geographic areas, and one or more ranked lists of the retailers believed to sell the greatest quantity of the suspect product. The rapid response cohort system 135 then contacts the most highly affected retailers to immediately inform them of which product(s) to remove from store shelves. The cohort system 135 also immediately contacts medical personnel in the most affected areas to put them on notice of potential effects of the suspect product in the event consumers are exposed thereto. Retailers and medical personnel in other affected areas can then be contacted in order of decreasing levels of impact (e.g., from most affected to least affected retailers and/or geographic areas).

Additionally, the rapid response cohort system 135 employs sales validation techniques to verify that notified retailers and/or geographies are complying with the FDA recall instructions. These sales validation techniques include reviewing data collected for sales occurring after the recall (e.g., Homescan® sales data) for sales of the recalled product. The example rapid response cohort system 135 also employs media monitoring services (e.g., Grabix®) to query media outlets for the affected geographies using one or more keywords related to the FDA recall concerns (e.g., occurrence of the term “e.coli” and “spinach”). In the event of an e.coli threat, the media monitoring services may identify a degree of discussion and/or notification to a viewing/listening audience. Persons and/or organizations chartered with recall communication efforts may use such information to determine whether, for example, additional communication efforts are needed in the interest of public safety.

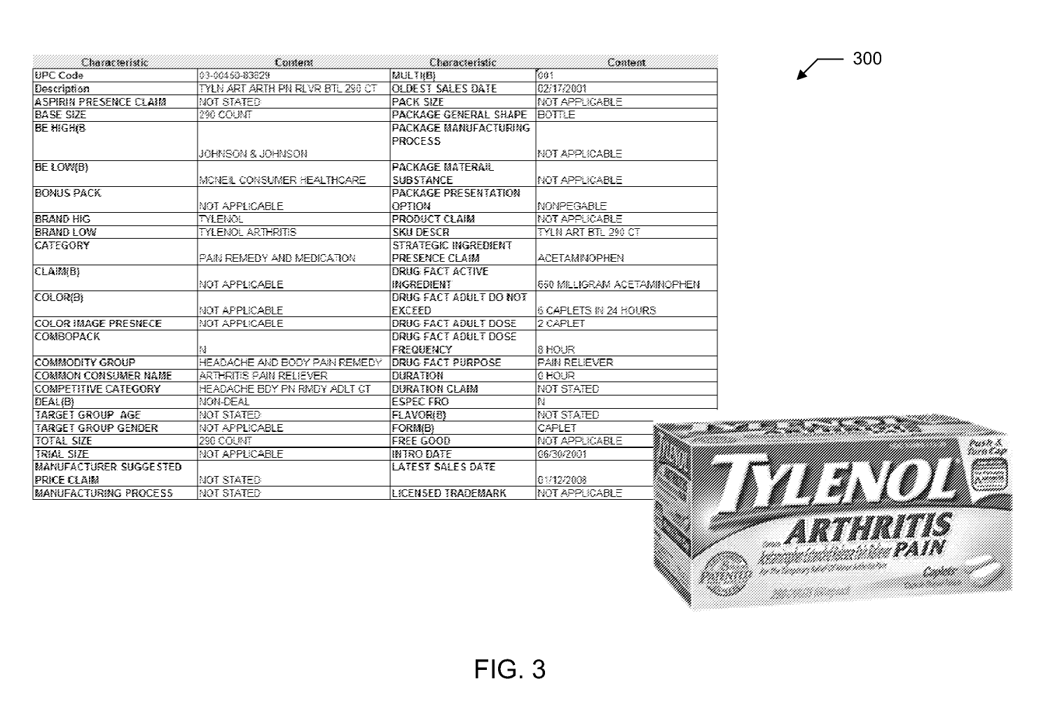

FIG. 3 illustrates an example table 300 of a portion of the Nielsen PRL. In the illustrated example of FIG. 3, the table 300 includes detailed coded data for a pain reliever product. More specifically, the example table 300 of FIG. 3 includes characteristics for Tylenol Arthritis caplets. In the illustrated example, the stored characteristics include a UPC code 302, a description of the product 304, a base size 306 (e.g., 290 count), a first brand name 308 (e.g., a high-level brand name such as “Tylenol”) and a second brand name 310 having additional specificity to the product (e.g., “Tylenol Arthritis”). Additionally, the example table 300 includes characteristics related to a product category 312, a package shape characteristic 314, a strategic ingredient presence claim characteristic 316 (e.g., “Acetaminophen”), and a quantity of such ingredient 318 (e.g., “650 Milligram Acetaminophen”). In some instances, the FDA may have all of these characteristic details, and potentially more. In other instances the FDA may have a much more limited list of key characteristics. Generally speaking, the fewer number of characteristics used to describe a product means a lower level of confidence that effective instructions can be disseminated to consumers and/or retailers in the event of a recall. As such, the example product reference library manager 172 supplements missing information, when needed. Although the Tylenol product is shown as an example product in FIG. 3 to illustrate the PRL, there is no intention to suggest that the Tylenol product has any likelihood of being subjected to an FDA recall.

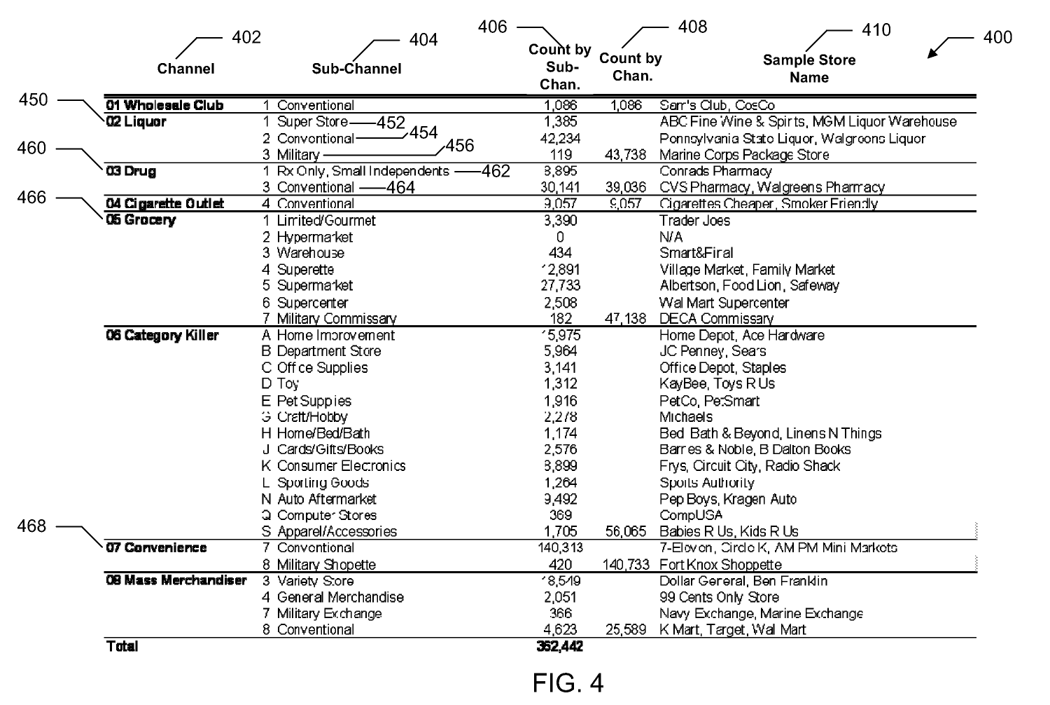

FIG. 4 illustrates an example table 400 of a collection of stores for which the TDLinx® system has data. The example table 400 illustrates retail and/or wholesale stores arranged by a channel column 402, a sub-channel column 404, a sub-channel store count column 406, and a channel store count column 408. Additionally, the example table 400 includes a sample store-name column 410 to illustrate representative store names for each sub-channel. Associated with each of the stores of the example table 400 is store characteristic data. As discussed above, the TDLinx® system tracks and stores data related to retail and/or wholesale stores such as, for example, merchant parent company information, store marketing groups, the number of stores in operation, store square footage, the number of employees at the store, the brands sold at the store (e.g., Coke®, Pepsi®), and/or the relative sales of the brands sold for each store.

Some of the stores in the example table 400 independently provide POS data to the market research entity or via the system 100, while other stores maintain their sales data in secret. For both the cooperative (i.e., those entities that provide data) and non-cooperative (i.e., those entities maintaining their data in secrecy) stores, one or more data collectors 106, and/or other systems may acquire, store, tabulate, and/or sell information related to the store(s). As discussed above, the Homescan® system, the Scantrack® system, the Claritas® services, and/or the Spectra® services may fill this role to track, acquire, and/or provide information associated with one or more stores. This information is used to place each of the stores in the relationship volume (e.g., cube) and to define cohorts.

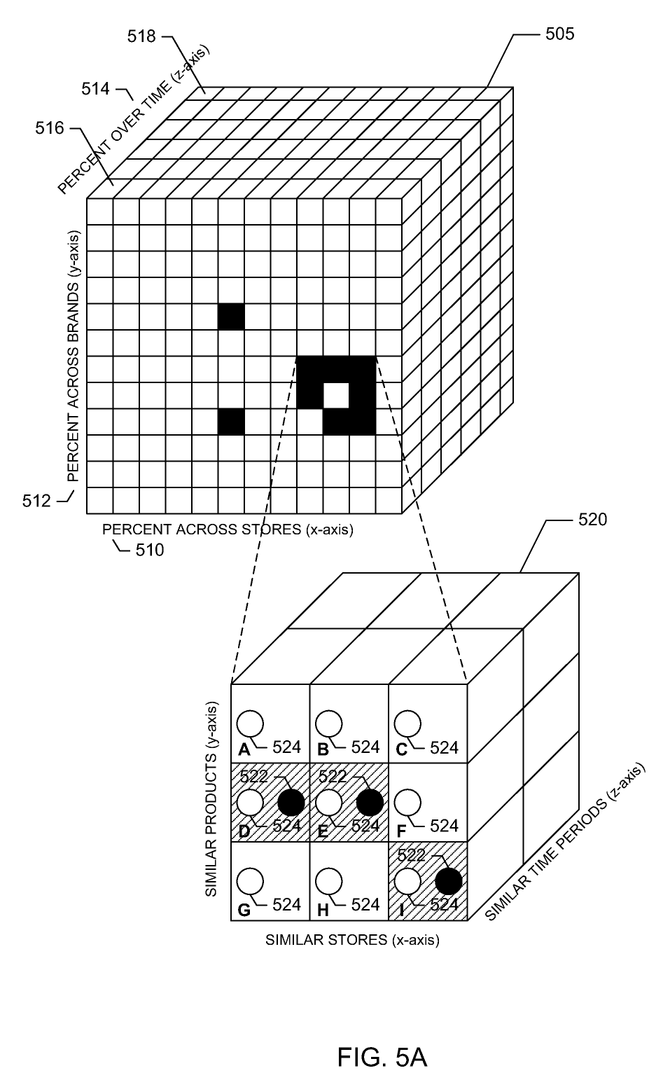

For purposes of illustration in the remainder of this description, the relationship volume will be referred to as a relationship cube. However, the volume need not have any particular shape and/or be limited to any particular number of dimensions. On the contrary, volumes of 2, 3, 4 or more dimensions are possible. Referring to FIG. 5A, the relationship cube 505 of the illustrated example includes data related to known stores as reflected in the market intelligence database 130. In particular, each cell in the cube represents a brand sales value for a specified period of time for each of the stores in the TDLinx® system. The location of each cell is based on its relationship(s) to other brands, other times, and other stores. In particular, the example cohort system 135 of the illustrated example creates the relationship cube 505 by placing stores in individual cells of the cube 505. The positions of the cells occupied by the specific stores are based on the degree of similarity between, for example, one or more TDLinx® characteristics of the stores of the cube 505. However, the positions of the cells may also be arranged in view of other characteristics including, but not limited to, the type(s) of product(s) sold, the type(s) of brand(s) sold by the store, and/or the quantity of any particular product(s) sold by the store. Thus, stores in adjacent cells will have one or more strongly similar characteristics. In contrast, stores in spatially distant cells will be less similar in the noted characteristics. In general, the farther cells are located from one another, the less similar those stores are, at least with respect to a characteristic used to select the cells. Stores with relatively fewer similarities are located in cells that are relatively farther separated from each other than are stores with relatively more similarities. For example, as the relative distance between cells along one axis (also referred to as a dimension) in the relationship cube 505 increases, the degree of similarity decreases for the stores located along that axis.

In the illustrated example of FIG. 5A, the relationship cube 505 is based at least in part on a characteristic of “Percent Across Stores” 510, which is shown along an x-axis. Additionally, the example relationship cube 505 of FIG. 5A is based at least in part on a characteristic of “Percent Across Brands” 512, which is shown along a y-axis. The example relationship cube 505 of FIG. 5A also is based at least in part on a characteristic of “Percent Over Time” 514, which is shown along a z-axis. Each of the axes of FIG. 5A may be referred to as a dimension. Thus, the example relationship cube 505 of FIG. 5A shows three such dimensions.

The characteristic data of “Percent Across Stores” 510 is a relative percentage rather than an explicit volume number, and reflects the percent of sales volume sold in each store with an estimated or observed number represented as a percent of all the selected product sales estimated to be in just this one store. The sum of all percentages in this store dimension (Percent Across Stores) equals 100%, thus stores may be aggregated to reflect one or more banners (e.g., particular store and/or merchant names), one or more channels (e.g., grocery stores, convenience stores, drug stores, etc.), and one or more regions (e.g., Northeast, sales territory “A,” DMAs, etc.). In theory, because the TDLinx® data includes approximately 400,000 stores, the x-axis (Percent Across Stores) will be approximately 400,000 cells in length, in which each cell corresponds to one store.

Each of the stores along this x-axis is located in a cell selected to reflect its relative similarity to every other store along that axis. For example, if one or more stores does not sell any particular brand of a particular product type (e.g., Coke® in the soft-drink type), then a cell for that store may reside on a left-most region of the x-axis or may, instead, be removed from the dimension for lack of applicability for the example product of interest. On the other hand, a store that sells only the Coke® soft drink in the soft-drink product type will reside on the right-most region of the x-axis.

Similarly, in the example of FIG. 5A, the characteristic data of “Percent Across Brands” 512 is another dimension which represents relative percentages of particular brands sold by corresponding stores. This dimension reflects a distribution of sales across one or more brands that make up a category expressed as a percentage that totals 100%. For example, one horizontal row along the y-axis may represent the brand Coke®, while a different row along the y-axis may represent Pepsi®. The y-axis 512 has a length corresponding to the number of brands carried by all the retail stores known by, for example, the TDLinx® system.

In view of the fact that a marginal (e.g., sometimes referred to as a percentage of sales) of any particular brand by any particular store may change over time, the z-axis 514 of FIG. 5A illustrates marginal values at discrete moments in time. The “Percent Over Time” dimension reflects the percent of multi-period sales estimated in any single period. For example, this dimension illustrates that a store or a product represented 10% of total sales in a first period (e.g., January) during the multi-period timeframe of one year. As the dimensional axis continues, a second period (e.g., February) may reveal 8% of total sales for the year, and so on. In the illustrated example relationship cube 505 of FIG. 5A, a first row 516 along the z-axis represents the most recent (in time) data reflecting the marginals for corresponding ones of the stores located along the x-axis and brands located along the y-axis. Correspondingly, a last row 518 along the z-axis represents the oldest known marginals for corresponding ones of the stores located along the x-axis and brands located along the y-axis. The marginals of a brand in a given store is also referred to herein as a “store mix.”

The relationship cube 505 may be implemented as a data structure and stored on a database, such as the example data store 145 of FIG. 1. Further, although referred to as a “cube,” the relationship cube 505 need not be a cube, but can have any other dimension(s). While the example relationship cube 505 of FIG. 5A includes three dimensions, these three dimensions are shown for ease of illustration. Additional dimensions for the relationship cube 505 may include, but are not limited to, the number of employees at the store(s), the annual revenue of the store(s), and/or the square footage of the store(s). For example, an additional axis (e.g., the “w-axis”) may reside on the relationship cube 505 to arrange the universe of approximately 400,000 stores from the TDLinx® database (or any other data source) in view of the number of employees working at each of those stores. In such an example, one extreme of the w-axis would include stores having only a single employee, while the opposite extreme of the w-axis would include stores having several hundred employees, or more. In this example, the nomenclature “cube” 505 would be at least a four-dimensional volume.

In addition to generating the relationship cube/volume 505, the example cohort spatial modeling engine 235 generates one or more store cohorts via spatial modeling techniques. As discussed in further detail below, the cohorts are defined with cells/stores from the relationship cube 505. An example store cohort 520 is shown in FIG. 5A. Each cohort may have any number of stores within it (e.g., ten stores, twenty stores, fifty stores, sixty stores, etc.), and stores may be members of multiple cohorts. One or more cohort(s) may be defined for each channel and/or sub-channel of interest. Briefly returning to FIG. 4, one example cohort may be generated based on a liquor channel 450, a drug-store channel 460, a grocery channel 466, and/or a convenience channel 468. In the illustrated table 400 of FIG. 4, because the liquor channel comprises approximately 43,000 stores, the cohort generated/defined by the spatial modeling engine could include that same number of retail and/or wholesale stores. However, the spatial modeling engine extracts stores from the relationship cube 505 and arranges those cells of the cohort so that relevant stores (i.e., stores in the liquor channel) are arranged within the cohort in proximity to each other based on their similarity of characteristics. Additionally or alternatively, a cohort may be generated based on a sub-channel, such as a super-store sub-channel 452, a conventional sub-channel 454, a military sub-channel 456, a small-independent drug-store sub-channel 462, and/or a conventional drug-store sub-channel 464.

The characteristics of each store may be ranked, grouped, and/or categorized by, for example, data obtained from the TDLinx® system (e.g., store location and/or store size). Store cohorts may, additionally or alternatively, be defined based on store data associated with shopper profiles (e.g., data provided by Spectra® and/or based on marketplace demand data (e.g., data provided by Claritas®). The characteristics may, additionally or alternatively, include competitive density and/or banner strategies. Using one or more of these channels (e.g., the TDLinx® channels), the spatial modeling engine 235 places stores of the same channel/sub-channel (extracted from the relationship cube 505) within cells of the cohort near each other based on the similarity of those stores' characteristics. For example, the spatial modeling engine 235 of the illustrated example may identify stores having a similar/same size as a characteristic factor of interest to determine relative proximity of the cells in which stores are placed. Any number of store characteristics may be employed by the spatial modeling engine 235 to generate one or more store cohorts 520 that are tailored to such characteristics of interest. The market researcher may constrain the generation of cohorts based on one or more particular channels of interest such as, for example, one or more of the channels and/or sub-channels identified by the TDLinx® system.

The example relationship cube 505 and/or cohort(s) 520 may be generated by the methods and apparatus described herein to, in part, further illustrate hierarchical relationships 550 of merchants. In the illustrated example of FIG. 5B, three example hierarchies identify relationships for retail outlets 552, product sales 554, and geographies 556. The example retail outlet hierarchy 552 may include a retail universe 558 at a highest (e.g., least granular) level, in which the example retail universe 558 may be represented by the relationship cube 505 having 400,000 stores therein. Such stores may be further segregated in view of one or more channels 560, such as example channels associated with standard and/or specialty store types. A further level of granularity in the example retail outlet hierarchy 552 includes one or more banners/accounts 562, such as particular store chains and/or independently owned/operated stores. A lowest level of granularity of the example retail outlet hierarchy 525 includes specific information 564 related to each individual banner/account, such as specific store location information, specific store employee quantity, and/or any other store characteristic of interest.

For purposes of explanation, and not limitation, the example hierarchical relationships 550 may include one or more product sales hierarchies 554. In the illustrated example of FIG. 5B, the product sales hierarchy 554 includes, at a highest (e.g., least detailed/granular) level, a product universe of Universal Product Codes (UPCs) 566. Such UPCs may be further identified based on, for example, one or more relevant categories 568 associated with the UPCs, such as categories related to clothing, baby products (e.g., diapers), soda, etc. Each of the identified categories may include one or more associated brands 570 that provide one or more products of the category to consumers. At a lowest level of granularity (e.g., a highest level of detail), each of the items 572 associated with the brands 570 are identified.

Also for purposes of explanation and not limitation, the example hierarchical relationships 550 may include one or more geographical hierarchies 556. In the illustrated example of FIG. 5B, the geographical hierarchy 556 includes, at a highest (e.g., least detailed/granular) level, a representation of the total United States sales area 574. For example, the merchant pool 105 may include merchant data 110, 115, 120, 125 from one or more disparate geographic regions 576. As described above, such regions may include one or more established sales territories (e.g., a Northeast sales territory, a Southwest sales territory) that, when specified and/or selected by a user, allows the geographic hierarchy 556 to tailor more detailed information based on one or more regions of interest. Each region may further include lower level detail related to one or more counties 578. Without limitation, such counties may include one or more aggregation(s) associated with, for example, markets of interest, sales territories of interest, and/or DMAs. Additional detail within each county 578 may include, but is not limited to, one or more zip codes 580 and/or aggregation(s) of retail trading area(s) and/or demonstration segments.

In the illustrated example of FIG. 5A, the cohort spatial modeling engine 235 employs the example reference manager 230 to populate each cohort 520 and/or relationship cube 505 with POS data 522 from, for instance, the Scantrack® system. The number of stores in the cohort may be determined by, in part, the need to contain some of the stores that have associated POS data. In other words, if a particular channel(s) of interest does not include a threshold number of stores having POS data, the example reference manager 230 identifies the closest available stores having POS data along any of the multiple dimensions (axes) of the relationship cube/volume 505. In the illustrated example of FIG. 5A, the store cohort 520 includes nine (9) frontal cells labeled “A” through “I.” Cells “D,” “E,” and “I” have POS data for their respective stores. However, as discussed above, not all merchants cooperate with the market research company operating the POS collection system to provide POS data. As a result, POS data voids appear in cells “A,” “B,” “C,” “F,” “G,” and “H.” In the example of FIG. 5A, POS data in each cell is calculated by the cohort reference manager 230 as a percentage of total sales for the respective merchant associated with that cell.

In the illustrated example of FIG. 5A, the example spatial modeling engine 235 invokes the services of the panelist manager 225 to populate cells of the store cohort 520 with Homescan® data 524. In the example cohort of FIG. 5A, nine cells have respective data 524, thereby indicating data for each of the corresponding nine stores has been acquired by statistically selected household panelists and saved to one or more databases of the Homescan® system. The Homescan® data 524 may include, but is not limited to, brand share data, account assortment data, and/or channel mix data. While data obtained from statistically selected panelists may be relied upon for predictions, cohort cells having actual POS data 522 (as shown (see crosshatch) with reference cells “D,” “E,” and “I”) further improve estimation efforts by grounding any such predictions in empirical data. Additionally, corrections may be made for stores without actual POS data prior to the predictions by comparing Homescan® data with shipment data. For example, data from a supplier may indicate that the retail store has received a quantity of goods, while the Homescan® data may indicate sales of those goods are 20% lower than the empirical shipment data. As a result, the market research entity may apply a correction/weighting factor to the Homescan® data to compensate for the difference. In the illustrated example of FIG. 5A, Homescan® data 524 in each cell is represented as a percentage of sales for the respective merchant associated with that cell as compared to the total sales of all merchants that may sell that particular product or brand of interest. As described above, the term “percentage of sales” is sometimes referred to as “marginals.” For example, the data 524 in cell “A” is calculated by the cohort panelist manager 225 to yield a percent of sales value (e.g., a marginal value) based on the cross product of three dimensions, such as brand share, account assortment, and channel mix.

In the illustrated examples of FIGS. 2 and 5, marginal values derived from POS data 522 and Homescan® data 524 are evaluated by the spatial modeling engine 235 to determine a difference score. The difference score may be calculated by, for example, taking the absolute value of the difference between the corresponding POS data and the Homescan® data. The difference scores allow estimates to be calculated for brand share and category mixes for the stores (cells) of the cohort 520 for which POS data is not available. For example, one can “scale-up” the Homescan® data for the uncooperative store based on the difference score from a corresponding cooperative store.

Additionally, the spatial modeling engine 235 models the POS data 522 to estimate brand and category sales rates per store in view of one or more relevant characteristics. For example, the spatial modeling engine 235 adjusts the sales rate estimates in view of seasonal differences, product size differences, and/or store types. In the case of, for example, barbecue sauces, adjustments are made based on winter, spring, summer, and fall sales differences. Furthermore, adjustments are made in view of estimated barbecue sauce bottle sizes sold during each respective season, in which, for example, larger barbecue bottle sizes are sold during the summer months and smaller bottle sizes are sold during the winter months.

While the example spatial modeling engine 235 can employ any kind of modeling technique, at least one specific type of model includes, for example, a spatial regression. Spatial regression methods capture spatial dependency in regression analysis, which may avoid statistical problems such as unstable parameters and unreliable significance tests, as well as providing information on spatial relationships among the variables involved. Depending on the specific technique, spatial dependency may enter the regression model as relationships between independent variables and dependent variables (e.g., season and corresponding sales volume of barbecue sauce). Additionally, spatial dependency can enter the regression model as relationships between the dependent variables and a spatial lag of itself, and/or in one or more error terms. Geographically weighted regression is a local version of spatial regression that generates parameters disaggregated by the spatial units of analysis. This allows assessment of the spatial heterogeneity in the estimated relationships between the independent and dependent variables.

The example spatial modeling engine 235 of FIG. 2 harmonizes (weights) predictions from the adjusted POS data 522 and the Homescan® data 524 by taking the average of the POS data and the Homescan® data. The average is then converted to a sales volume value and then further converted into a relative measure based on one or more constraints (e.g., mid-size stores, convenience stores in a geographic region, etc.) provided by the client to focus the results on a topic of interest. The results 140 are provided to the client and/or market research company as output volume data, tracking reports, drill-down analysis results, and/or account tracking and planning data.

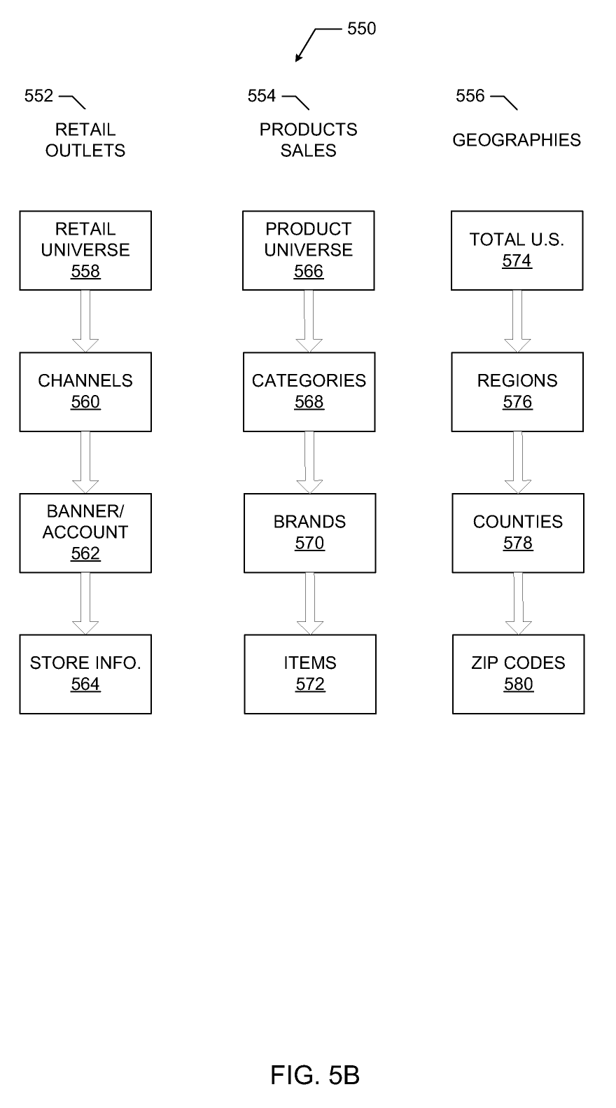

FIG. 6 illustrates an example table 600 of reference stores and prediction stores. The illustrated table 600 of FIG. 6 includes a stores column 605, a drugstore column 610, a grocery store column 615, a mass-merchandiser column 620, and a total column 625. The example table 600 also includes a reference row 630, a predictions row 635, and a coverage rate row 640. Reference stores 630 include retailers and/or wholesalers that cooperate with the market research company operating the example system 100 to provide actual POS data. As discussed above, such example merchants are shown in cells “D,” “E,” and “I” of FIG. 5A. The drugstore column 610 includes 481 reference stores and 110 prediction stores. The 110 prediction stores may be, for example, hold-out (unrepresentative) stores that do not cooperate with the market research company operating the example system 100 by providing POS data. As described above, POS data for stores that do not provide actual POS data may be estimated using the Homescan® data 524 of FIG. 5A. The coverage rate row 640 illustrates that 4.4 reference stores are available for each prediction store.

The example table 600 of FIG. 6 operates as a validation and assists a market research entity to ascertain particular strengths and/or weaknesses of available data. For example, the coverage rate row 640 of FIG. 6 illustrates a considerably greater coverage rate for grocery stores (i.e., 12.3) versus the coverage rate for mass-merchandiser stores (i.e., 1.4). As a result, the merchants (e.g., retailers and/or wholesalers) research entity may recognize this deficiency and seek to remedy it by focusing development resources on particular channels and/or retailers to procure additional reference data. Similarly, the example table 600 of FIG. 6 may allow the market research entity to assign weighting/correction factors in a manner proportional to the coverage rate. For example, higher weighting/correction factors may be assigned when harmonizing sales estimations and/or predictions based on, for example, the Homescan® data when the coverage rate is, accordingly, lower.

Traditionally, when a new merchant was approached to cooperate with a market research entity to provide, for example, POS data (e.g., to the Scantrack® system), the merchant was required to format their delivered data in a predetermined manner. For example, the merchant typically employed development resources to parse their sales data from their internal retail data systems and generate an output data format that complied with a predetermined data template. However, some merchants choose not to participate because of the effort required to comply with such predetermined data templates. Furthermore, the merchants may not cooperate with the market research entity because they see insufficient value in return for cooperating, even when the merchant is offered compensation for such participation. Additionally, the merchants sometimes fear that their disclosed data may be discovered and/or accessed by competitive merchants in this common template format. Some merchants addressed these concerns by providing the market research entity with data from random weeks of the year. For example, a Retailer “A” cooperates with the market research entity, but limits the provided data to five (5) random weeks out of the year.

However, unlike traditional approaches to receiving POS data, the example system 100 to facilitate sales estimates described herein adapts to the data that the merchants choose to provide. As such, the example system 100 does not require merchant(s) to adapt to a predetermined template. While the data provided by a particular merchant may not be as inclusive of granular detail (e.g., the number of lemon versus orange Jello® boxes sold), the example method(s) and apparatus to facilitate sales estimates illustrated herein still improve sales predictions and product coverage because each defined cohort comprises both POS data and data derived from one or more market research tools (e.g., TDLinx®, Scantrack®, etc.). As more stores, more products, and/or more data is aggregated over time, the relationship cube 505 of the example system 100 becomes more robust and yields better predictions because the cohort(s) extracted therefrom reflect more product coverage. Prediction accuracy improves as data is aggregated, and the accuracy of predictions is also improved when the cohorts are more similar.

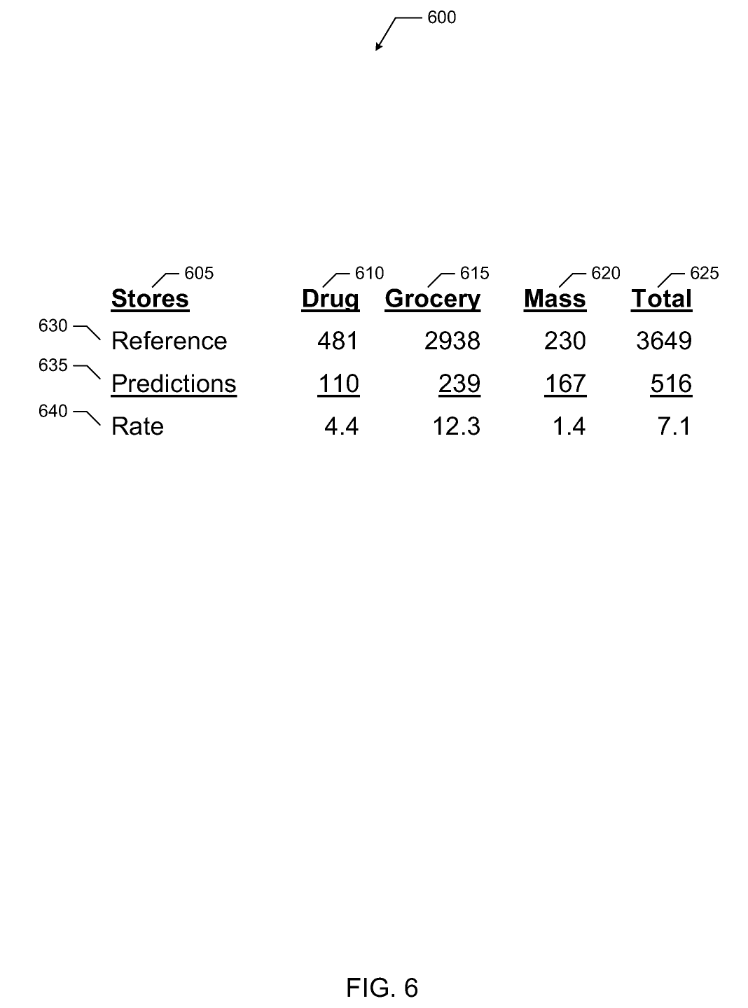

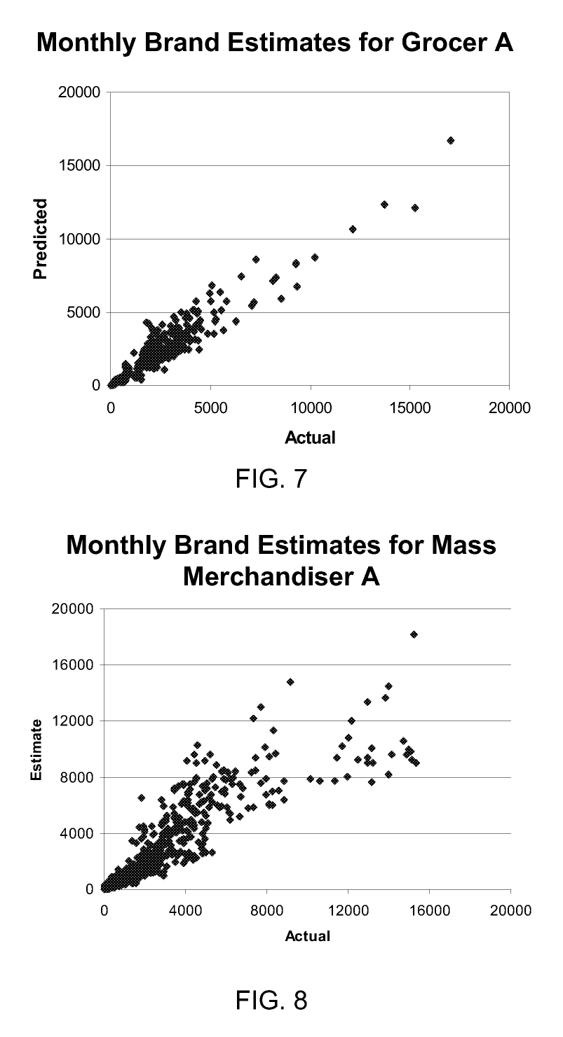

FIGS. 7 and 8 illustrate differences in the accuracy of monthly brand estimates achieved with relatively high versus relatively low coverage rates. In particular, FIG. 7 illustrates the monthly brand estimates for Grocer A, which corresponds to the 12.3% coverage rate for grocery stores shown in FIG. 6. On the other hand, FIG. 8 illustrates the monthly brand estimates for Mass Merchandiser A, which corresponds to the 1.4% coverage rate for mass-merchandiser stores shown in the mass-merchandiser column 620 of FIG. 6. Generally speaking, the results for monthly Grocer A volume estimates for all selected brands (e.g., Duracell®, Coke®, Pampers®) in selected categories (e.g., batteries, soft-drinks, diapers) in view of data from one or more divisions of the United States is in line with a 20% accuracy target. On the other hand, the results for monthly Mass Merchandiser A volume estimates for all selected brands in selected categories in view of the data from one or more divisions of the United States is not as good as the predictions for Grocer A. However, despite the difference in accuracy, errors in excess of 20% still allow the market research entity and/or client to determine valuable metrics related to trend observations.

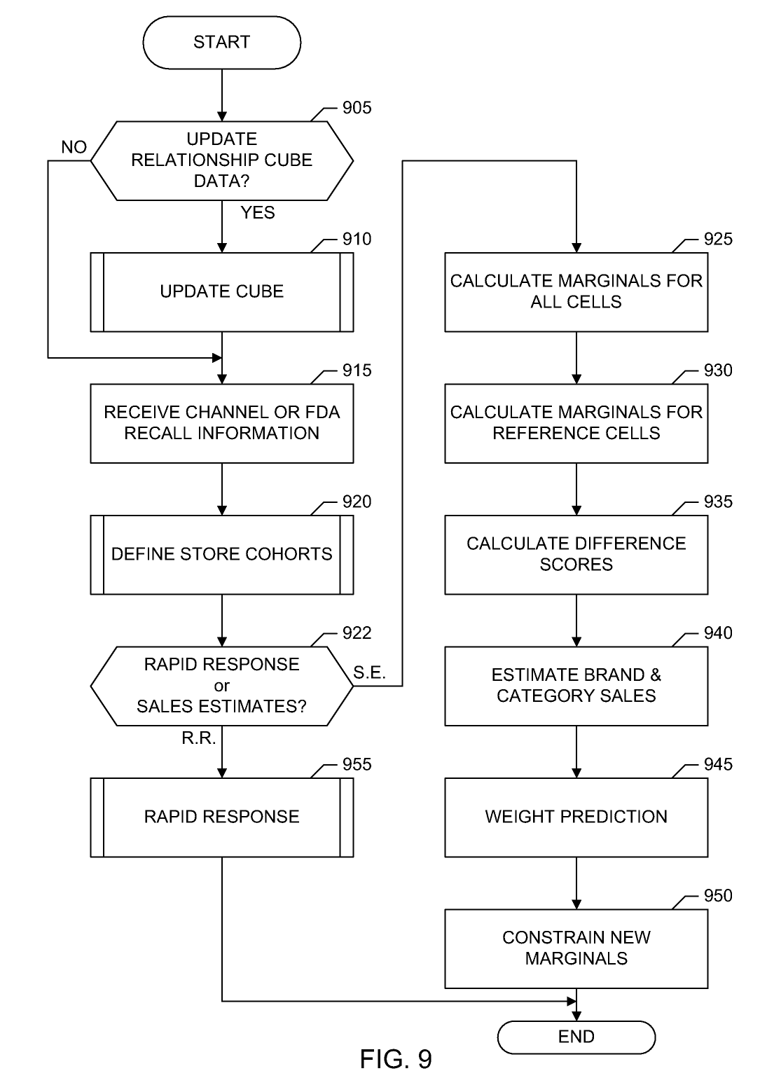

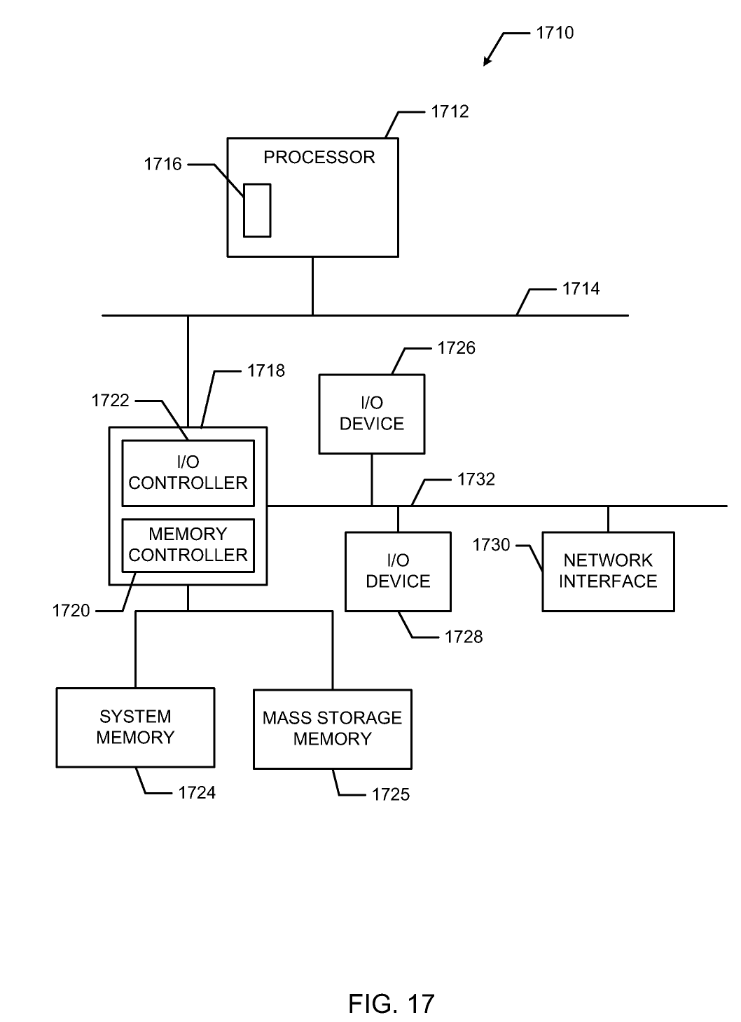

Flowcharts representative of example machine readable instructions for implementing the system 100 of FIGS. 1 and 2 are shown in FIGS. 9-12, 14, and 16. In this example, the machine readable instructions comprise one or more programs for execution by one or more processors such as the processor 1712 shown in the example processor system 1710 discussed below in connection with FIG. 17. The program(s) may be embodied in software stored on a tangible medium such as a CD-ROM, a floppy disk, a hard drive, a digital versatile disk (DVD), or a memory associated with the processor 1712, but the entire program and/or parts thereof could alternatively be executed by a device other than the processor 1712 and/or embodied in firmware or dedicated hardware. For example, any or all of the data collectors 106, the example demographics manager 160, the example household panelist manager 162, the example consumer target manager 164, the example merchant definition manager 166, the example point-of-sale manager 168, the example media manager 170, the example product reference library manager 172, the example supply chain manager 174, the example rapid response, the example rapid response cohort manager 135, the cohort definition manager 220, the cohort panelist manager 225, the cohort reference manager 230, and/or the modeling engine 235 could be implemented (in whole or in part) by software, hardware, firmware and/or any combination of software, hardware, and/or firmware.

Thus, for example, any of the example data collectors 106, the example demographics manager 160, the example household panelist manager 162, the example consumer target manager 164, the example merchant definition manager 166, the example point-of-sale manager 168, the example media manager 170, the example product reference library manager 172, the example supply chain manager 174, the example rapid response cohort manager 135, the cohort definition manager 220, the cohort panelist manager 225, the cohort reference manager 230, the subscriber manager 231, the medical resource manager 232, the validation manager 233, and/or the modeling engine 235 could be implemented by one or more circuit(s), programmable processor(s), application specific integrated circuit(s) (ASIC(s)), programmable logic device(s) (PLD(s)), and/or field programmable logic device(s) (FPLD(s)), etc. When any of the appended claims are read to cover a purely software and/or firmware implementation, at least one of the example data collectors 106, the example demographics manager 160, the example household panelist manager 162, the example consumer target manager 164, the example merchant definition manager 166, the example point-of-sale manager 168, the example media manager 170, the example product reference library manager 172, the example supply chain manager 174, the example rapid response cohort manager 135, the cohort definition manager 220, the cohort panelist manager 225, the cohort reference manager 230, the subscriber manager 231, the medical resource manager 232, the validation manager 233, and/or the modeling engine 235 are hereby expressly defined to include a tangible medium such as a memory, DVD, CD, etc. (storing such software and/or firmware).

Further still, although the example program is described with reference to the flowchart illustrated in FIGS. 9-12, 14, and 16, many other methods of implementing the example system 100 may alternatively be used. For example, the order of execution of the blocks may be changed, and/or some of the blocks described may be changed, divided, eliminated, omitted, combined, and/or implemented in any other way.

The program of FIG. 9 begins at block 905 where the example rapid response cohort system 135 determines whether to update cells within the relationship cube 505, or whether to proceed with predictions and/or recall responses based on existing data. Updates to the cube 505 occur based on, for example, changes in the marketplace. Such marketplace changes include new stores opening, stores closing, new products in the marketplace, seasonal variations, merchant remodeling efforts, and/or changes in shopping patterns. As described above, the relationship cube 505 contains data related to retail stores and/or wholesalers, which may include, but is not limited to, store characteristics, shopper characteristics, location information, point of sale (POS) information, panelist information, product(s) carried, particular product(s) carried, and/or brand-share information. Such information may be acquired from a diverse range of market research entities, tools, and/or services chartered with the responsibility of market data acquisition. In the illustrated example, tools that contribute data used within the relationship cube 505 include, but need not be limited to, the Homescan® system, the Claritas® services (including Claritas® BusinessPoint™), the TDLinx® system, the Nielsen PRL, and/or the Scantrack® system.

Each of the market research tools accumulate and/or make available large quantities of market data for clients and/or subscribers to the rapid response system 100. As a result, the user of the example rapid response cohort system 135 may decide (block 905) to perform a relationship cube update (block 910) once per quarter, and/or more frequently, such as during evening or early morning hours so that market research activities may be performed during workday hours. At least one benefit to a periodic early morning hour update(s) includes an ability to more accurately respond to FDA recall notices with up-to-date data. On the other hand, the user of the example rapid response cohort system 135 may proceed with market analysis or responses to FDA recalls, in which the rapid response cohort system 135 receives a seed channel (channel of interest) from the user, and/or FDA recall information (block 915) to be considered during the analysis. In the event of receipt of FDA recall information, the seed channel is selected by the rapid response system 100 based on a traditional channel known to service the suspect product identified by the FDA. For example, if the FDA identifies a consumer food product (e.g., chili sauce 10 fluid ounce can), then the seed channel may be selected as grocery stores. However, if the FDA identifies an over-the-counter drug, then the seed channel may be selected as drug-stores. As described in further detail below, the selected seed channel is used as a first pass to determine stores related to the suspect product before considering secondary channel(s). Secondary channels for an over-the-counter drug may include, for example, grocery store channel(s) and/or convenience store channel(s).

The example spatial modeling engine 235 of the cohort system 135 employs one or more spatial models and/or spatial modeling techniques to generate one or more store cohorts based on a channel (e.g., liquor, grocery, etc.) and/or sub-channel (e.g., liquor super-store, liquor conventional store, grocery supermarket, gourmet grocery store, etc.) represented by, for example, the TDLinx® universe, as shown in FIG. 4.

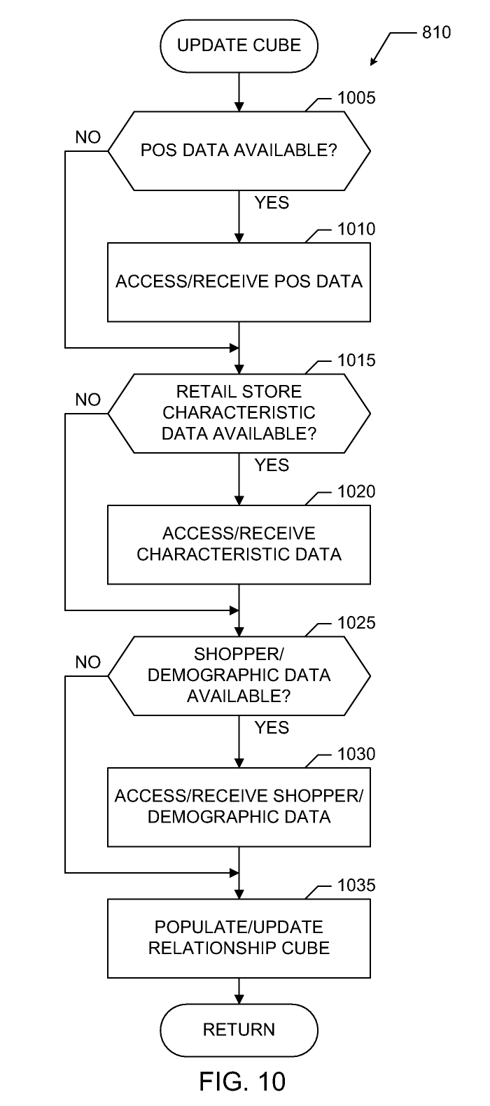

Briefly referring to FIG. 10, a flowchart 910 is shown, which is representative of example machine readable instructions that may be executed to update the example relationship cube 505 of FIG. 5A. The flowchart 910 of FIG. 10 begins at block 1005 in which the example cohort reference manager 230 determines whether additional POS data is available from a market research tool chartered with the responsibility of tracking and/or collecting POS information for one or more stores. An example market research tool that provides POS data to the example system is the Scantrack® system, as described above. If POS data is available (block 1005), then the example cohort reference manager 230 negotiates a connection with, for example, the Scantrack® system via the example point-of-sale manager 168 and downloads new and/or updated POS data (block 1010). The POS data is then associated with one or more of the appropriate cells of the relationship cube 505. As noted above, each cell is associated with a store.

The POS information retrieved from the example Scantrack® system may include UPC barcode information and/or details related to the individual products scanned and/or otherwise sold by the retailer. In view of the retrieved UPC information from the Scantrack® system, the example rapid response system 100 may employ the Nielsen PRL to further confirm specific details about the products purchased at the POS retailers. Without limitation, product UPCs from consumer purchases may be received from the Homescan® system via the example household panelist manager 162. As described above, some retailers refuse to participate with market researchers and keep scanned purchase data private. However, the statistically selected panelists in the Homescan® system are chartered with the responsibility of self-scanning purchased products after visiting one or more retailers. As such, specific product information may be derived via the Homescan® system, even for retailers that do not cooperate with the Scantrack® system.

On the other hand, if new and/or updated POS data is not available (block 1005), then the example cohort definition manager 220 determines whether new and/or updated store characteristic data (e.g., store size, number of store employees, store location, etc.) is available (block 1015) from at least one market research tool chartered with the responsibility of tracking and/or collecting store characteristic information. An example market research tool that provides store characteristic information to clients is the TDLinx® system, as described above. If store data is available (block 1015), then the example cohort definition manager 220 negotiates a connection with, for example, the TDLinx® system and downloads new and/or updated store characteristic data via the example merchant definition manager 166 (block 1020).

If new and/or updated store characteristic data is not available (block 1015), or upon completion of downloading new and/or updated store characteristic data (block 1020), the example cohort definition manager 220 determines whether new and/or updated shopper and/or demographic data is available (block 1025) from at least one market research tool chartered with the responsibility of tracking and/or collecting such information. Example market research entities that provide shopper and/or demographic data are the Claritas® and Spectra® systems. If shopper and/or demographic data is available (block 1025), then the example cohort definition manager 220 negotiates a connection with, for example, the Claritas® system and downloads new and/or updated shopper and/or demographic data via the example demographics manager 160 (block 1030).

The example rapid response cohort manager 135, the example cohort definition manager 220, the example cohort panelist manager 225, and/or the example cohort reference manager 230 may negotiate information transfer services between one or more market research tools by way of agreed service contracts. For example, a client using the example rapid response cohort manager 135 may have established service agreements with the Homescan® system, the TDLinx® system, the Scantrack® system, and/or any other market research tools and/or entities, to access and download market data. Authentication procedures may be employed by the cohort definition manager 220, the cohort panelist manager 225, and/or the cohort reference manager 230 to access the information, such as by way of a user identifier and associated password. Additionally or alternatively, each of the demographics manager 160, the household panelist manager 162, the consumer target manager 164, the merchant definition manager 166, the point-of-sale manager 168, and/or the Nielsen PRL manager 172 may be chartered with the responsibility of accessing respective sources from the data systems 150, when needed.

In the illustrated flowchart 910 of FIG. 10, information obtained from any of the market research tools capable of providing market data to the user of the example rapid response cohort manager 135 is saved to the relationship cube 505 (block 1035). For example, the relationship cube 505 may store data retrieved from one or more data sources (e.g., one or more databases and/or associated structured query language (SQL) engines) in the data store 145. The example data store 145 facilitates storage for the relationship cube 505 and the one or more dimensions therein. Each unique product category and/or store added to the relationship cube/volume 505 (block 1035) will have a corresponding location within the cube 505 at an intersection of one or more dimensions. In the event that, for example, a new pet food store is added to the relationship cube 505, the spatial modeling engine 235 identifies a candidate intersection point in the cube 505. The dimensions that relate to the example pet food store (i.e., a specialty store) may cause some non-specialty stores to be deemed similar in certain circumstances. For example, the example pet food store may align closely with a general grocery store in terms of the characteristic(s) related to volume sales for a specific pet food brand. However, the same pet food store may not align very closely with the same general grocery store in terms of TDLinx® characteristics, such as store size.

As such, for each separate axis of the cube/volume 505, the spatial modeling engine 235 identifies corresponding candidate insertion points/cells. While the ultimate insertion point/cell (e.g., for the new pet food store) selected by the example spatial modeling engine 235 may be calculated based on an average location of each axis (e.g., a triangulated average in the event of a three dimensional cube), the spatial modeling engine 235 may employ any other spatial selection technique. For example, the spatial modeling engine 235 may employ, without limitation, the spatial regression techniques described above.

Returning to FIG. 9, in view of the received seed channel and/or received FDA recall information (block 915), the example rapid response cohort manager 135 defines one or more store cohorts, such as the example cohort 520 of FIG. 5A. In particular, the cohort spatial modeling engine 235 defines the cohort 520 by retrieving cells from the relationship cube 505 such that adjacent cells represent a higher degree of characteristic similarity (e.g., similarity of a store size, a store geographic location, a number of store employees, the volume sold of a particular product, the volume sold of a particular brand of product, etc.) than cells that are separated from each other. For example, the cohort spatial modeling engine 235 may extract a cohort 520 based on a grocery store channel (e.g., grocery store) in view of a characteristic of interest (e.g., the number of employees at the store, the volume sold of a particular product, the volume sold of a particular brand of product, etc.). While the relationship cube 505 may have thousands of stores within the grocery store channel, the particular cohort 520 defined by the spatial modeling engine 235 arranges cells (e.g., cells “A” through “I” shown in FIG. 5A) associated with stores based on the characteristics of interest (e.g., how many employees work in those stores).

For example, each of the stores having a similar number of employees are arranged in the cohort 520 in adjacent proximity. Stores having between, for example, 25-39 employees that are relevant to the particular channel of interest (e.g., grocery stores, food, clothing, etc.) are extracted from the relationship cube 505 and are placed in cohort cells having a farther proximity to those cells that represent the stores having, for example, four-hundred employees. As a simple illustration, if cell “E” within the example cohort 520 of FIG. 5A represents a grocery store having forty employees, then cell “D” may represent a grocery store having between 25-39 employees, and cell “F” may represent a grocery store having between 41-55 employees. The cells extracted from the relationship cube 505 may reside anywhere within the cube 505. For example, while a first store may be similar to a second store in view of a food category, those stores may have very few similarities with a clothing category. In that example category of clothing, the same first store may be much more similar to a third store than it is to the second store.

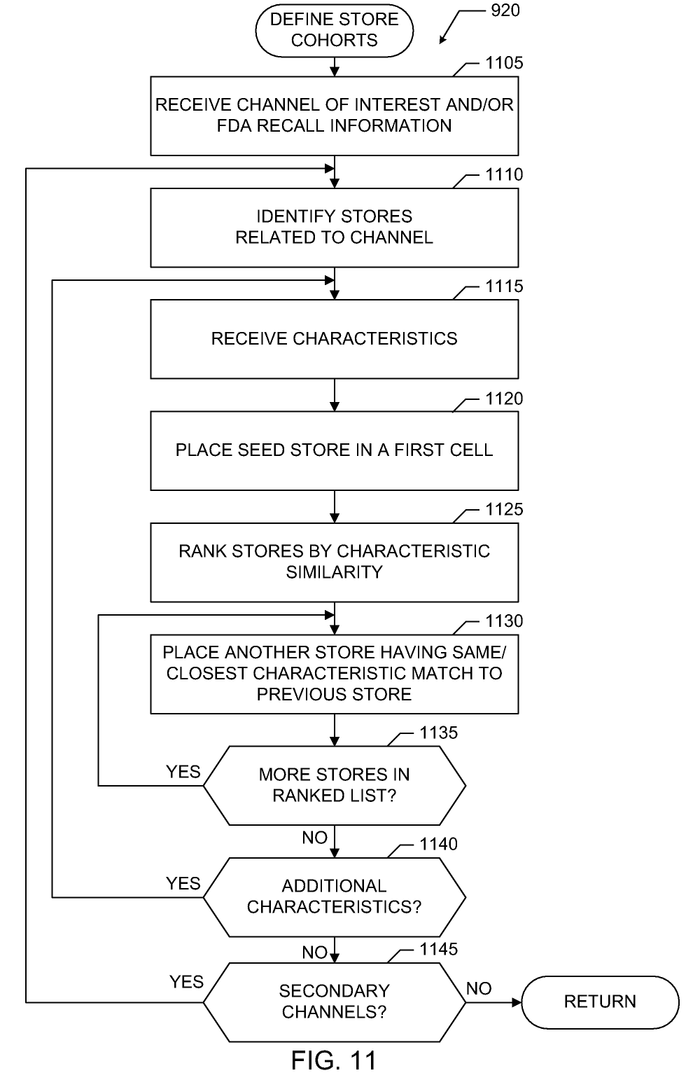

Referring to FIG. 11, a flowchart 920 is shown, which is representative of example machine readable instructions that may be executed to define the example store cohort 520 of FIG. 5A. The flowchart 920 of FIG. 11 begins at block 1105 in which the example modeling engine 235 receives the channel of interest and/or FDA recall information. As described above, the spatial modeling engine 235 identifies one or more stores from the relationship cube 505 fitting the identified channel of interest (block 1110). However, this channel of interest is a preliminary identification of stores within a first of two or more channels to be considered. Relevant stores may not be associated with the initial channel of interest. Thus, additional and/or alternate channels will also be considered in an effort to determine a thorough cohort of stores relevant to the characteristic of interest, as described in further detail below. Also discussed above, the number of stores slated for the cohort may be related to the number of stores related to any particular channel, such as approximately 43,000 stores for the “liquor” channel shown in FIG. 4.

The definition manager 220 receives one or more characteristics of interest as inputs defined by an operator of the system 100, and/or characteristics related to the FDA recall information. Such characteristics are selected to facilitate investigation and/or analysis of the channel of interest (block 1115). Characteristics may include, for example, the recalled product name (e.g., Big Pharm Buzz stomp), the recalled product type (e.g., over-the-counter pain relievers), the recalled product size (e.g., 190 count of capsules), and/or the recalled product UPC. The market intelligence sources 130a may include a wide range of data, such as store characteristics 205, shopper profile data 210, and/or marketplace characteristics 215. As described above, the store characteristics 205 may be obtained via the TDLinx® services, the shopper profile data 210 may be provided by Spectra® and/or the Homescan® system, and the marketplace characteristics 215 may be provided by Claritas.

A single store that closely matches the channel of interest and at least one of the received characteristic(s) is placed in a first cell as a seed to build the cohort 520 (block 1120). Other retailers/merchants from the same channel are ranked based on a relative similarity to one or more of the characteristics of interest based on data received from the market intelligence source(s) (block 1125). For example, if a characteristic of interest is the number of employees for the channel of grocery stores, then the example cohort modeling engine 235 creates a ranked list of grocery stores from the least number of employees to the greatest number of employees (block 1125). In another example, if a characteristic of interest is volume sales of Big Pharm painkillers, then the example rapid response cohort modeling engine 235 creates a ranked list of drug-stores that, on one extreme, include stores that sell very few Big Pharm products and, on the opposite extreme, include stores that sell the most Big Pharm products within the drug-store channel (block 1125) Once all ranking is complete (e.g., a ranked list has been created for such characteristic of interest), the modeling engine 235 then begins placing the ranked stores in their corresponding cells in the example cohort 520 based on the ranked lists. For instance, the modeling engine 235 selects a first store from the ranked list of employee count and places it in the cohort based on its relationship(s) to the seed cell (block 1130). Or in view of the aforementioned drug-store example, the modeling engine 235 selects a first store from the ranked list of volume-of-pain-killer sales and places the store with the greatest volume of sales in the cohort based on its relationship to the seed cell (block 1130). The spatial modeling engine 235 then determines if there are additional stores in need of spatial placement in the example cohort 520 (block 1135). If additional stores are still in the list (i.e., not yet placed in a cell of the cohort 520) (block 1135), the example process 920 returns to block 1130. As a result of the process, all ranked stores are placed in the cohort. For example, all grocery stores having 40 employees are placed in the cohort 520 by the spatial modeling engine 235 so that they are adjacent to other such stores having 40 employees. Additionally, stores that deviate from 40 employees are placed in the cohort 520 in cell locations a distance away from the 40 employee cells that reflects the difference in employee counts, as described above.

While the example above describes definition of one or more cohorts with one characteristic of interest, the example flowchart 920 of FIG. 11 may repeat to allow one or more additional characteristics to be considered when defining the cohort. As shown in the illustrated example flowchart 920 of FIG. 11, the modeling engine 235 determines if additional characteristics of interest are to be considered when defining the cohort (block 1140). If so, control returns to block 1115 and placement of a seed store (block 1120) may be skipped. In the event of multiple characteristics being considered for the cohort, the example ranking of stores by characteristic similarity (block 1125) results in a compound ranking. However, if the example modeling engine 235 determines that additional characteristics of interest are not to be considered (block 1140), then the modeling engine 235 determines whether there are any secondary channels to be considered that might be relevant to the characteristics of interest (block 1145). As described above, some recalled products are associated with a primary category, such as a drug-store category for over-the-counter pain killers (e.g., Big Pharm painkillers). However, if alternate channels are not explored then a potentially substantial amount of retailers could be omitted from consideration. For example, although the drug-store channel is typically a default choice with respect to pain-killers, grocery stores are also known to sell relatively large quantities of over-the-counter drugs, too. As such, if secondary channels of interest are deemed appropriate for further investigation (block 1145), then control returns to block 1110.

Moreover, repetition of the example flowchart 920 of FIG. 11 may also occur in an effort to identify one or more stores that match one or more characteristics of interest (e.g., sales of a particular product, sales of a particular type of product, etc.), but may not necessarily have a primary association with the received channel of interest (block 1105). Continuing the example recall of an over-the-counter pain reliever (e.g., Big Pharm painkillers), the primary channel of interest (block 1105) is likely to be drug-stores. Returning briefly to FIG. 4, the TDLinx® table 400 includes a drug channel 460, which is further divided into a sub-channel of Rx only/small independent drug stores 362, and a sub-channel of conventional drug stores 364 (e.g., CVS Pharmacy, Walgreens Pharmacy, etc.).

However, although the drug channel 360 includes retail stores that are most likely to carry the suspect product pain reliever, one or more secondary channels may also sell the potentially harmful product identified by the FDA recall notice. In another example, the recalled pain reliever product may also be sold in substantial quantities through a grocery store category 366 and/or a convenience store category 368. As such, the example flowchart 920 of FIG. 11 repeats to consider additional stores in the alternate store categories that have one or more matching characteristics. Additional category considerations result in a cohort (e.g., the example cohort 520 of FIG. 5A) having a more thorough representation of stores that could be candidates for immediate notification of FDA warnings and/or instructions.

Returning to FIG. 9, upon completion of building the one or more cohorts, such as the example cohort 520 of FIG. 5A, the example rapid response cohort system determines whether one or more sales estimates are to be performed, or whether one or more FDA recall notices are to be processed (block 922). In the event that sales estimates are to be performed (block 922), then cells of the example cohort 520 are further populated by the example cohort panelist manager 225 with any information calculated from, for example, Homescan® data (block 925). For example, the POS based data may be the cross product of three dimensions to yield a marginal value. As described above, the cross product may include, but is not limited to dimensions of brand share, account assortment, and/or channel mix, wherein such data is referred to herein as “percent of sales,” “margin data,” and/or “marginals.”

Once any POS data of interest has been added to the cohort, the example cohort reference manager 230 populates reference cells of the example cohort 520 with any marginal calculations of interest to the analysis at issue (block 930). In the illustrated example of FIG. 5A, reference cells include cells “D,” “E,” and “I.” In the illustrated example, the marginal calculations (block 930) are derived from POS observations received from, for example, the Scantrack® system.

Differences between the marginals in the reference cells (e.g., cells “D,” “E,” and “I” of FIG. 5A) and the prediction cells (e.g., all cells “A” through “I”) are calculated by the spatial modeling engine 235 to generate difference scores (block 935). Sales projection accuracies may be improved by grounding calculations in some observed metric, such as the actual observed POS data provided by the Scantrack® system. As a result, estimations for factors such as brand share and category mix may be determined (block 940) with a higher degree of confidence. In the illustrated example, the averages of the difference calculations between the reference cells and the projection cells are then calculated to determine prediction weights (block 945). Higher weights may be applied to data that is based on a relatively higher empirical observation, such as POS data from the Scantrack® system. The weights are applied to the sales output data as a constraint for client output (block 950).

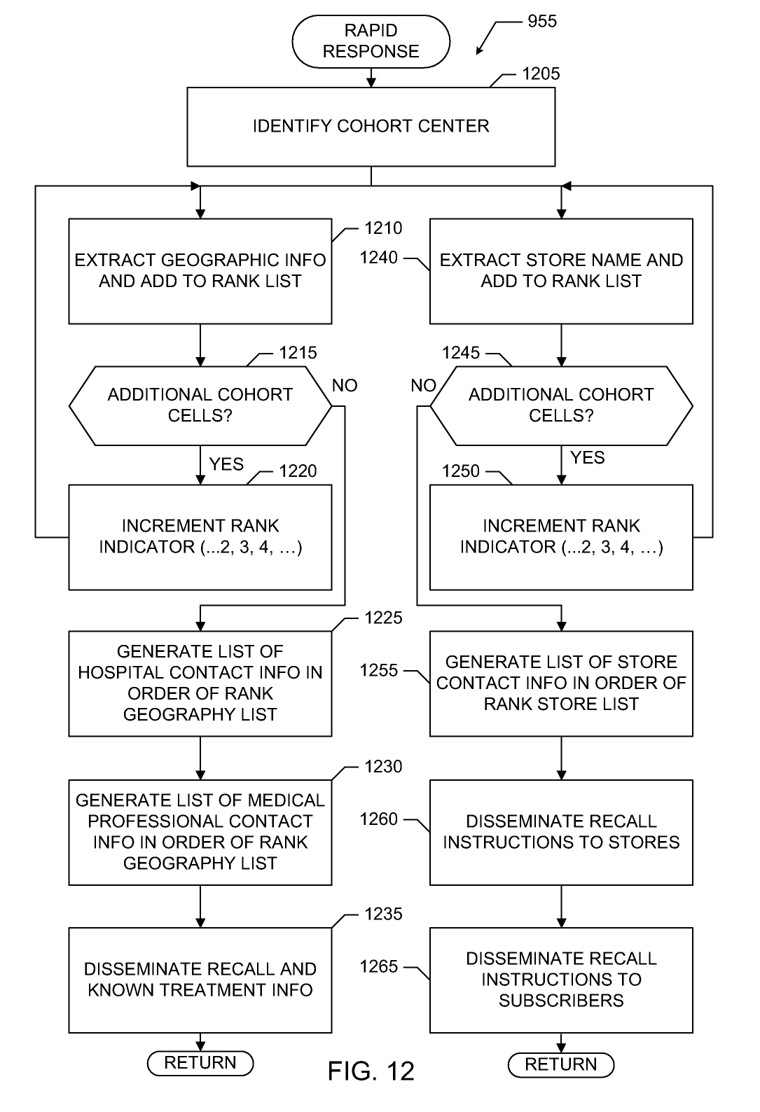

Returning to block 922, and assuming that FDA recall notices are to be processed (block 922), the rapid response system 100 initiates recall processing (block 955). Referring to FIG. 12, a flowchart 955 is shown, which is representative of example machine readable instructions that may be executed to perform recall processing. The flowchart 955 of FIG. 12 begins at block 1205 in which the spatial modeling engine 235 of the rapid response cohort system 135 identifies the center of the cohort to be analyzed. As described above, because the cohort represents store similarities in a spatial manner with respect to how strongly each store matches with one or more characteristics of interest (e.g., the volume sales for Big Pharm Buzz Stomp), the centermost cell of the cohort is associated with the store that is most strongly associated with the characteristic of interest. The example flowchart 955 of FIG. 12 bifurcates to address geographical aspects of the cohort and store details of the cohort. Although the above example cohorts are generated in view of one or more stores, cohort generation is not limited thereto. One or more cohorts may be generated based on, for example, relevant medical personnel located near the affected FDA recall geography. Additionally, one or more additional and/or alternate cohorts may be generated to identify medical professional specialties that may be relevant to the type of recall being addressed such as, for example, gastrointestinal specialists, disease specialists, poison specialists, and/or allergy specialists.

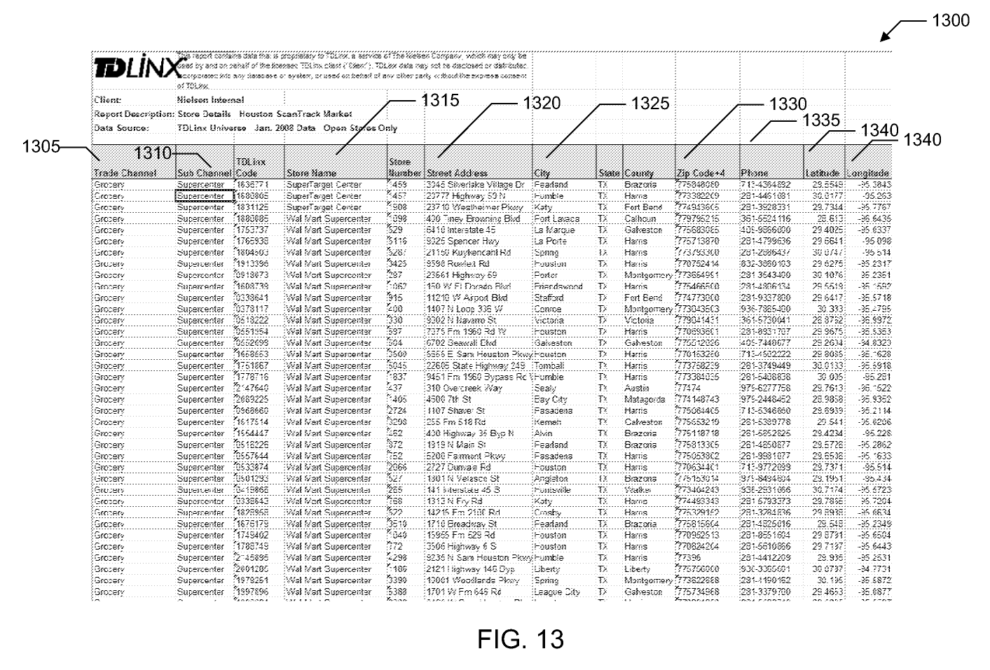

In the illustrated example of FIG. 12, the definition manager 220 of the rapid response cohort system 135 extracts the geographic location associated with a cell of the cohort (block 1210), which, in the first-pass through the flowchart 955, is associated with the cohort center cell previously identified by the spatial modeling engine 235. Turning briefly to FIG. 13, an additional view of a TDLinx® table 1300 is shown. Each row of the example table 1300 represents a store and each column describes details related to the store. In the illustrated example of FIG. 13, the table 1300 includes a trade channel column 1305, a sub-channel column 1310, a store name column 1315, a street address column 1320, a city column 1325, a zip code column 1330, a phone number column 1335, a latitude 1340, and a longitude 1345 column. As a result, the geography information extracted and appended to a rank list by the example definition manager 220 (block 1210) may include any or all of the street address, zip code, latitude, and/or longitude.

If there exist additional cells in the cohort (block 1215), the rank list increments a rank indicator (block 1220) so that the next list entry is represented as less closely matched to the characteristic of interest than the previous entry. In other words, the first cell of the cohort (i.e., the center cell) is associated with the first ranked position within the geographic rank list because it corresponds to the geography in which the characteristic of interest has the greatest impact. Accordingly, as cells further away from the center of the cohort are analyzed, the corresponding rank value for each subsequent cell (and corresponding geographic location) is increased (e.g., rank “1” is the most significantly associated with the characteristic, rank “2” is less associated with the characteristic than rank “1,” but more so than rank “3,” and so on). The example flowchart 955 of FIG. 12 iterates blocks 1210, 1215 and 1220 until all cells of the cohort have been analyzed.

The example medical resource manager 232 generates a list of hospital contact information based on the geographic information in the rank list (block 1225). For example, if the first geographic information in the rank list identifies the city of “Humble, Tex.” having a corresponding zip code of “77338” (see row 1350 of FIG. 13), then the medical resource manager 232 accesses the demographics manager 160 to determine proximate hospitals. As described above, at least one of the Claritas® services includes the Claritas® BusinessPoint™, which contains business data such as hospital telephone numbers for such hospitals proximate to the geography of interest. Additionally, the example medical resource manager 232 generates a corresponding list of medical professionals that are most suited to address one or more effects of exposure to the suspect product (block 1230). For example, if the suspect product has the effect of causing severe stomach irritation, then the example medical resource manager 232 solicits the demographics manager 160 for medical professionals that specialize in gastrointestinal specialties (block 1230). With the generated list of contact information for hospitals and appropriate medical professionals, the example rapid response cohort system 135 disseminates the FDA recall information, information related to symptoms of exposure to the suspect product, and treatment information to each of the hospitals and/or medical professionals in the rank lists (block 1235). Such information dissemination may occur by way of e-mail messages, automated telephone calls, and/or pager numbers. Without limitation, the rank lists generated by the example definition manager 220 may be used by FDA personnel to initiate contact with those geographies that are likely to be most severely affected by the recall.

In the illustrated example of FIG. 12, the definition manager 220 of the rapid response cohort system 135 extracts the specific store name/information associated with a cell of the cohort and adds it to a ranked store list (block 1240). During the first-pass through the flowchart 955, the first cell analyzed by the definition manager 220 is associated with the cohort center cell previously identified by the spatial modeling engine 235. Turning briefly again to FIG. 13, the TDLinx® table 1300 includes a contact phone number for each store, which may be saved in the ranked store list (block 1240). If there exist additional cells in the cohort (block 1245), the rank store list increments a rank indicator (block 1250) so that the next entry is represented as less closely matched to the characteristic of interest than the previous entry.

The definition manager 220 generates a list of store contact information in the order of the ranked store list and, if needed, employs the example demographics manager 160 to obtain any additional information for each store (block 1255). As described above, additional information may include, but is not limited to, contact information, telephone numbers, store manager name(s), store e-mail address(es), and/or store headquarters information. With the generated rank list of store contact information, the example rapid response cohort system 135 disseminates the FDA recall information and/or specific item-removal requirements to each of the stores in the list (block 1260). Additionally, the example subscriber manager 231 disseminates such recall information to those individuals and/or groups that subscribe to the service of the rapid response system 100, such as media outlets (e.g., television stations, radio stations, newspapers), consumers, shipping warehouse distributors, and/or consumer watchdog groups (block 1265) (e.g., the Consumers Union, the Center for Food Safety, Food and Water Watch, the Center for Science in the Public Interest, etc.). The process of FIG. 12 then ends.

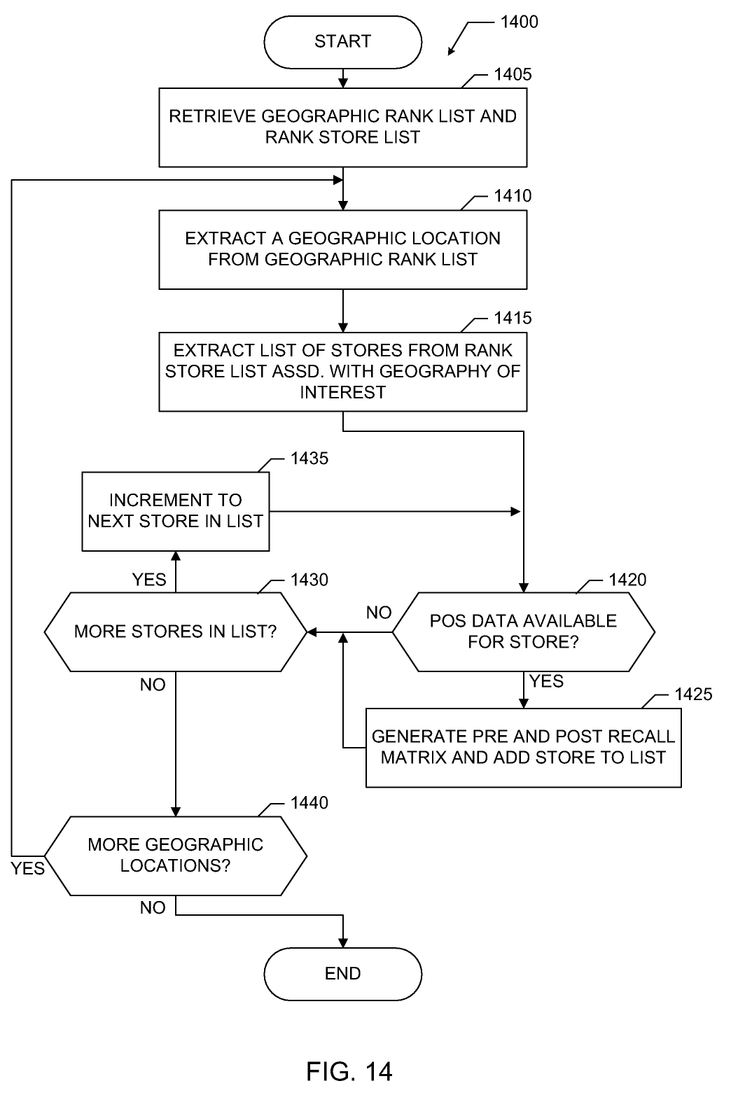

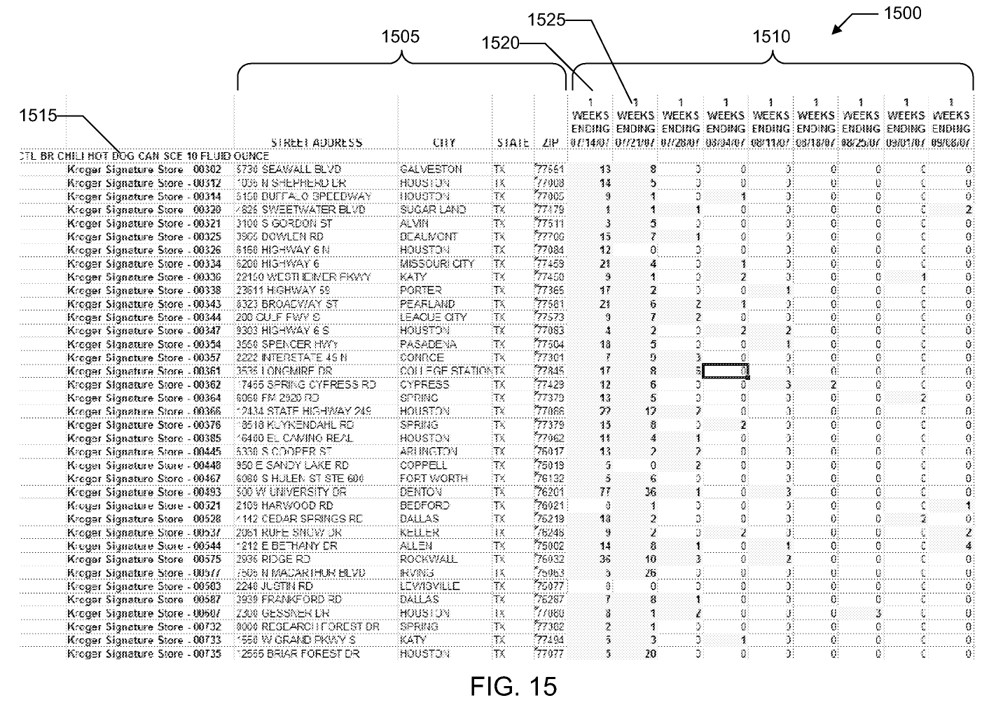

FIG. 14 is a flowchart 1400 representative of example machine readable instructions that may be executed to validate the effect of the FDA recall notice on one or more retailers, merchants, and/or wholesalers that had previously sold the suspect product. In the illustrated example of FIG. 14, the validation manager 233 retrieves the geographic rank list and the ranked store list previously generated by the definition manager 220 (block 1405). Starting with the first geographic region identified in the geographic rank list, the example validation manager 233 extracts the geographic location information (e.g., a city, a zip code, latitude, longitude, etc.) (block 1410). Additionally, the validation manager 233 extracts a list of stores from the ranked store list that are associated with the geographic location information (block 1415) and determines whether a store on the list has available POS information (e.g., such as POS information from Scantrack®) (block 1420). If POS data is available for the selected store, then the example validation manager 233 generates a pre-recall/post-recall retail matrix (block 1425), such as the example recall retail matrix 1500 shown in FIG. 15.

In the illustrated example of FIG. 15, each row of the recall retail matrix 1500 represents one store, in which each store has associated location information columns 1505 and associated aggregate sales of the suspect product arranged chronologically 1510. For example, assuming that the suspect product identified by the FDA recall is a 10 fluid ounce can of chili hot dog sauce 1515, a first chronological column 1520 indicates a base-line of sales of the suspect product prior to the recall notice. In an effort to assess the impact of the success or failure of the recall notification efforts and/or compliance with FDA demands to remove the offending product from retail shelves, a second chronological column 1525 illustrates sales of the suspect product one week later. While the illustrated example of FIG. 15 shows seven additional columns of sales data for the suspect product, any number of columns may be realized to ascertain recall compliance, both before and/or after the date of the recall notice.

Returning to FIG. 14, after adding a store with POS data to the recall matrix 1500 (block 1425), the validation manager 233 determines if there are more stores in the received rank store list (block 1430). If so, the list is incremented to the next store (block 1435) and the example validation manager 233 determines whether POS data is available for that store (block 1420). Otherwise, if there are no additional stores in the rank store list (block 1430), the example validation manager 233 determines whether additional geographic locations are to be analyzed from the received geographic rank list (block 1440). If so, then control returns to block 1410 to analyze one or more stores that may reside within the next geographic location of interest that was affected by the recall notice.

Post recall notification activity may also be reviewed by way of media activity via the Nielsen® Grabix® system. The Grabix® system provides a user with occurrences of relevant keywords used during media broadcasts. Media broadcasts are digitized by the Grabix® system and further analyzed to determine whether or not relevant keywords have been recited by, for example, a news anchor. For example, in response to an FDA recall notice, a keyword “e.coli” may be particularly relevant to gaining a better understanding of how aggressive the attempts are to inform a viewing audience of the recall notice.

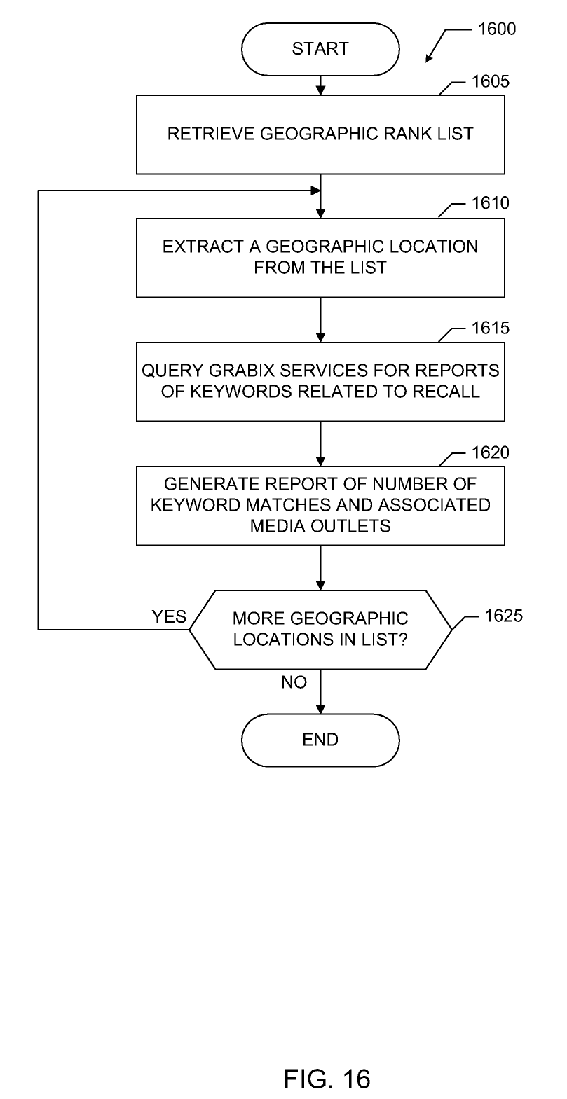

In the illustrated example flowchart 1600 of FIG. 16, the example validation manager 233 retrieves the geographic rank list generated by the definition manager 220 (block 1605) and extracts a geographic location from the list (block 1610). The first geographic location extracted (e.g., during the initial iteration of the example flowchart 1600 of FIG. 16) is that geographic location that is believed to be most significantly affected by the FDA recall. One or more queries are performed by the media manager 170 based on keywords deemed relevant to the FDA recall (block 1615) (e.g., “e.coli,” “spinach,” etc.). The example validation manager 233 and/or the example media manager 170 generates one or more reports related to the number of instances in which the keywords of interest were recited by one or more media outlets (e.g., news television stations, radio stations, etc.) (block 1620). If additional geographic locations are left to be examined from the received geographic rank list (block 1625), control returns to block 1610 so that one or more media outlets of the alternate/additional geographic locations may be evaluated.

FIG. 17 is a block diagram of an example processor system 1710 that may be used to execute the example machine readable instructions of FIGS. 9-12, 14, and 16 to implement the example systems, apparatus, and/or methods described herein. As shown in FIG. 17, the processor system 1710 includes a processor 1712 that is coupled to an interconnection bus 1714. The processor 1712 includes a register set or register space 1716, which is depicted in FIG. 17 as being entirely on-chip, but which could alternatively be located entirely or partially off-chip and directly coupled to the processor 1712 via dedicated electrical connections and/or via the interconnection bus 1714. The processor 1712 may be any suitable processor, processing unit or microprocessor. Although not shown in FIG. 17, the system 1710 may be a multi-processor system and, thus, may include one or more additional processors that are identical or similar to the processor 1712 and that are communicatively coupled to the interconnection bus 1714.

The processor 1712 of FIG. 17 is coupled to a chipset 1718, which includes a memory controller 1720 and an input/output (I/O) controller 1722. A chipset typically provides I/O and memory management functions as well as a plurality of general purpose and/or special purpose registers, timers, etc. that are accessible or used by one or more processors coupled to the chipset 1718. The memory controller 1720 performs functions that enable the processor 1712 (or processors if there are multiple processors) to access a system memory 1724 and a mass storage memory 1725.

The system memory 1724 may include any desired type of volatile and/or non-volatile memory such as, for example, static random access memory (SRAM), dynamic random access memory (DRAM), flash memory, read-only memory (ROM), etc. The mass storage memory 1725 may include any desired type of mass storage device including hard disk drives, optical drives, tape storage devices, etc.

The I/O controller 1722 performs functions that enable the processor 1712 to communicate with peripheral input/output (I/O) devices 1726 and 1728 and a network interface 1730 via an I/O bus 1732. The I/O devices 1726 and 1728 may be any desired type of I/O device such as, for example, a keyboard, a video display or monitor, a mouse, etc. The network interface 1730 may be, for example, an Ethernet device, an asynchronous transfer mode (ATM) device, an 802.11 device, a digital subscriber line (DSL) modem, a cable modem, a cellular modem, etc. that enables the processor system 1710 to communicate with another processor system.

While the memory controller 1720 and the I/O controller 1722 are depicted in FIG. 17 as separate functional blocks within the chipset 1718, the functions performed by these blocks may be integrated within a single semiconductor circuit or may be implemented using two or more separate integrated circuits.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
receiving product recall information;
generating at least one store cohort based on the received product recall information to represent a plurality of stores spatially arranged based on relative similarities to at least one channel;
generating at least one ranked list of contact information based on the at least one store cohort; and
disseminating the received product recall information to an entity associated with the contact information.

2. A method as defined in claim 1, wherein generating the at least one store cohort further comprises associating a preliminary channel of interest with the received product recall information.

3. A method as defined in claim 2, wherein the preliminary channel of interest comprises at least one of a grocery channel, a drug channel, a convenience channel, or a wholesale club channel.

4. (canceled)

5. A method as defined in claim 1, wherein generating the at least one store cohort further comprises receiving characteristics associated with the received product recall information.

6. A method as defined in claim 5, wherein the received characteristics comprise at least one of a recalled product name, a recalled product type, a recalled product size, or a recalled product universal product code.

7. A method as defined in claim 1, wherein generating the at least one store cohort comprises a spatially arranged array including at least three dimensions based on the relative similarities to the at least one channel.

8. A method as defined in claim 1, wherein generating the at least one store cohort comprises representing a plurality of stores in a spatially arranged array based on relative similarities to at least one characteristic associated with the received recall information.

9. A method as defined in claim 1, wherein generating the at least one ranked list of contact information comprises extracting geographic information associated with each representation of a store in the at least one store cohort.

10-11. (canceled)

12. A method as defined in claim 9, wherein a first contact information of the at least one ranked list is associated with a center of the at least one store cohort.

13. A method as defined in claim 9, wherein the at least one ranked list of contact information comprises at least one of hospital contact information or medical professional contact information.

14. A method as defined in claim 13, wherein the medical professional contact information comprises a medical specialty associated with the received product recall information.

15. A method as defined in claim 1, wherein generating the at least one ranked list of contact information comprises extracting store information associated with each representation of a store of the at least one store cohort.

16. A method as defined in claim 15, wherein the store information may comprise at least one of a store name, a store telephone number, a store manager name, a store e-mail address, or store headquarter information.

17. A method as defined in claim 15, wherein a first store information of the at least one ranked list is associated with a center cell of the at least one store cohort.

18. A method as defined in claim 17, further comprising associating subsequent store information with the at least one ranked list based on a relative distance from the center of the at least one store cohort.

19. A method as defined in claim 17, further comprising contacting each of the stores in the at least one ranked list in order of proximity to the center cell.

20. An apparatus to respond to a product recall comprising:
a market intelligence database to store data indicative of a plurality of merchants and a plurality of medical professionals; and
a rapid response cohort system to receive product recall information, identify affected merchant locations in the plurality of merchant locations, identify medical professionals in the plurality of medical professionals proximate respective ones of the affected merchant locations, and generate a first cohort containing a plurality of cells, each of the cells representing a corresponding one of the affected merchant locations, the cells being placed in the cohort based on at least two relationships between the affected merchant locations.

21. An apparatus as defined in claim 20, further comprising a data collector to acquire the data indicative of the plurality of affected merchant locations and the plurality of medical professionals.

22-23. (canceled)

24. An apparatus as defined in claim 21, wherein the data collector comprises a merchant definition manager to retrieve information indicative of merchant information.

25. An apparatus as defined in claim 24, wherein the merchant definition manager retrieves at least one of merchant name, merchant location, merchant geographic coordinates, merchant phone numbers, merchant addresses, or merchant manager names.

26. (canceled)

27. An apparatus as defined in claim 21, wherein the data collector comprises a product reference library manager to retrieve information indicative of product details.

28. An apparatus as defined in claim 27, wherein the product reference library manager retrieves at least one of a product name, a product type, a product size, a product category, a product active ingredient, or a product universal product code.

29-30. (canceled)

31. An apparatus as defined in claim 20, wherein the rapid response cohort system further comprises a spatial modeling engine to apply at least one spatial modeling technique to the recall information, and the data indicative of the plurality of merchants, the spatial modeling engine to generate the first cohort.

32. An apparatus as defined in claim 31, wherein the spatial modeling engine generates a second cohort based on data indicative of the medical professionals.

33. An apparatus as defined in claim 32, wherein the spatial modeling engine generates a third cohort based on data indicative of at least one medical professional specialty.

34. (canceled)

35. An apparatus as defined in claim 20, further comprising a subscriber manager to disseminate recall information to a plurality of subscribers affected by the recall information.

36. An apparatus as defined in claim 20, further comprising a medical resource manager to retrieve the data indicative of the plurality of medical professionals.

37. (canceled)

38. An apparatus as defined in claim 20, further comprising a validation manager to retrieve information indicative of post-recall sales of a recalled product to measure recall compliance.

39. A method to validate post-product recall compliance comprising:
generating a ranked list of geographies affected by a product recall;
generating a ranked list of stores affected by the recall;
retrieving point-of-sale data from at least one store in the ranked list of stores associated with a corresponding geography; and
identifying a quantity of recalled product sold at the at least one store after a recall date.

40. A method as defined in claim 39, further comprising generating a matrix to illustrate the quantity of recalled product sold at the at least one store before and after the recall to determine product recall communication impact.

41-53. (canceled)
